(19) United States
(12) Patent Application Publication
(10) Pub. No.: US 2026/0219598 A1
(43) Pub. Date: Jul. 30, 2026

(54) ELECTROPHOTOGRAPHIC MEMBER, PROCESS CARTRIDGE AND ELECTROPHOTOGRAPHIC IMAGE FORMING APPARATUS

(71) Applicant: CANON KABUSHIKI KAISHA, Tokyo (JP)

(72) Inventors: Shunsuke Tango, Tokyo (JP); MASAHIRO WATANABE, Shizuoka (JP); TAKAYUKI HIRATANI, Tokyo (JP); RYO OGAWA, Kanagawa (JP)

(21) Appl. No.: 19/183,301

(22) Filed: Apr. 18, 2025

Related U.S. Application Data
(63) Continuation of application No. PCT/JP2023/038328, filed on Oct. 24, 2023.

(30) Foreign Application Priority Data
Oct. 25, 2022 (JP) 2022-170590

(51) Int. Cl. G03G 15/02; G03G 15/08

(52) U.S. Cl. CPC G03G 15/0233; G03G 15/0818

(57) ABSTRACT

An electrophotographic member having a conductive elastic layer, wherein the elastic layer contains a urethane elastomer and a conductive filler, the urethane elastomer contains a matrix and a plurality of domains dispersed in the matrix, and in a cross section of the elastic layer in which the domain and the matrix are exposed, the relationship between the parameter A indicating a viscoelasticity term of the domain and the parameter B indicating a viscoelasticity term of the matrix measured in a predetermined viscoelasticity image satisfies A<B, the micro rubber hardness of the elastic layer at a temperature of 23° C. is 20 to 50 degrees, and a strain 5 seconds after unloading measured by a predetermined method at a temperature of 23° C. is not more than 1.00 μm.

### CROSS-REFERENCE TO RELATED APPLICATION

This is a continuation of International Application No. PCT/JP2023/038328, filed on Oct. 24, 2023, and designated the U.S., and claims priority from Japanese Patent Application No. 2022-170590, filed on Oct. 25, 2022, the entire content of which is incorporated herein by reference.

### BACKGROUND OF THE INVENTION

### Field of the Invention

The present disclosure provides an electrophotographic member used in an electrophotographic image forming apparatus (hereinafter simply referred to as an “image forming apparatus”) such as an electrophotographic system copying machine and a printer. In addition, the present disclosure also provides a process cartridge and an electrophotographic image forming apparatus.

### Description of the Related Art

An image forming apparatus using an electrophotographic system (a copying machine, facsimile, or printer using an electrophotographic system) is mainly composed of an electrophotographic photosensitive member (hereinafter referred to as a “photosensitive member”), a charging apparatus, an exposure apparatus, a developing apparatus, a transfer apparatus and a fixing apparatus.

In the image forming apparatus, the photosensitive member is first charged by a charging member (hereinafter referred to as a “charging roller”) and then exposed to light and an electrostatic latent image is formed on the photosensitive member. In addition, a toner in a toner container is applied onto a toner carrying member (hereinafter referred to as a “developing roller”) by a toner control member, and transported to a developing zone by the developing roller. Thus, the toner transported to the developing zone develops the electrostatic latent image on the photosensitive member in the contact region between the photosensitive member and the developing roller. Then, the toner on the photosensitive member is transferred to recording paper by a transfer unit and fixed by heat and pressure. The toner remaining on the photosensitive member is removed by a cleaning member.

Conventionally, an elastic layer of such a developing roller or charging roller is required to have fast recovery from deformation, that is, a low compression set and a low micro rubber hardness. Therefore, as materials for the elastic layer, vulcanized rubber with a high electrical resistance such as silicone rubber, acrylonitrile butadiene rubber, and epichlorohydrin rubber have been used.

On the other hand, the elastic layer is also required to have conductivity. Since the vulcanized rubber has a high electrical resistance, a conductive filler such as carbon black may be contained in the elastic layer in order to make it conductive. However, the conductive filler may increase the micro rubber hardness of the elastic layer and increase the compression set.

For example, an increase in the micro rubber hardness of the elastic layer increases the stress that is applied to the toner by the developing roller. In addition, an increase in the compression set of the elastic layer may result in, for example, a phenomenon in which, when a developing roller in a stationary state is in contact with a toner control member for a long time, the deformation of the contact region of the developing roller with the toner control member is not easily recovered. Partial deformation of the developing roller causes uneven development. In addition, an increase in the compression set of the elastic layer may result in, for example, a phenomenon in which, when a charging roller in a stationary state is in contact with a photosensitive drum for a long time, the deformation of the contact region of the charging roller with the photosensitive drum is not easily recovered. Partial deformation of the charging roller causes uneven charging of the photosensitive drum.

Japanese Patent Application Publication No. 2017-116685 discloses a conductive member for electrophotographic instruments, having an elastic layer including a conductive first polymer phase containing one or more polymers, a non-conductive second polymer phase that contains one or more polymers and is present separately from the first polymer phase, and an interfacial phase that contains a compatibilizer composed of a polymer containing either or both of the component constituting the polymer contained in the first polymer phase and the component constituting the polymer contained in the second polymer phase, and is present between the first polymer phase and the second polymer phase. Japanese Patent Application Publication No. 2017-116685 describes that, according to the conductive member for electrophotographic instruments, when the non-conductive phase is present in the conductive elastic component layer, a low hardness and low sagging that cannot be achieved with the conductive phase are exhibited, and when both phases are uniformly finely dispersed, charging can be controlled at the toner size level, resistance unevenness is curbed, and excellent charging properties are exhibited.

### SUMMARY OF THE INVENTION

The inventors studied the conductive member for electrophotographic instruments disclosed in Japanese Patent Application Publication No. 2017-116685. As a result, they found that, in the conductive member for electrophotographic instruments disclosed in Japanese Patent Application Publication No. 2017-116685, there is still room for improvement in the recovery from deformation.

At least one aspect of the present disclosure is to provide an electrophotographic member having high conductivity, a low hardness, and excellent recovery from deformation. In addition, at least one aspect of the present disclosure is to provide a process cartridge that contributes to stable formation of a high-quality electrophotographic image. In addition, at least one aspect of the present disclosure is to provide an electrophotographic image forming apparatus that can stably form a high-quality electrophotographic image.

According to at least one aspect of the present disclosure,
there is provided an electrophotographic member comprising a conductive elastic layer,
wherein the elastic layer comprises a urethane elastomer and a conductive filler,
the urethane elastomer comprises a matrix and a plurality of domains dispersed in the matrix,
a relationship between a parameter A indicating a viscoelasticity term of the domain and a parameter B indicating a viscoelasticity term of the matrix, which are measured in a viscoelasticity image of a cross section of the elastic layer in which the domain and the matrix are exposed under a scanning probe microscope, satisfies A<B,
micro rubber hardness of the elastic layer at a temperature of 23° C. is 20 to 50 degrees, and
when a Vickers indenter is brought into contact with the matrix on the outer surface of the elastic layer at a temperature of 23° C., the Vickers indenter is pressed into the elastic layer at a load rate of 10 mN/30 seconds, a load of 10 mN is maintained for 60 seconds, and the load is then removed, a strain 5 seconds after unloading is not more than 1.00 μm.

In addition, according to at least one aspect of the present disclosure,
there is provided a process cartridge that is detachable from a main body of an electrophotographic image forming apparatus, comprising the electrophotographic member according to the present disclosure.

In addition, according to at least one aspect of the present disclosure,
there is provided an electrophotographic image forming apparatus comprising the electrophotographic member according to the present disclosure.

According to at least one aspect of the present disclosure, it is possible to obtain an electrophotographic member having high conductivity, a low hardness, and excellent recovery from deformation. In addition, according to at least one aspect of the present disclosure, it is possible to obtain a process cartridge that contributes to formation of a high-quality electrophotographic image. In addition, according to at least one aspect of the present disclosure, it is possible to obtain an electrophotographic image forming apparatus that can form a high-quality electrophotographic image.

Further features of the present invention will become apparent from the following description of exemplary embodiments with reference to the attached drawings.

### BRIEF DESCRIPTION OF THE DRAWINGS

FIGS. 1A and 1B are schematic cross-sectional views showing an example of an electrophotographic member according to one aspect of the present disclosure.

FIGS. 2A and 2B are schematic cross-sectional views showing one embodiment of an elastic layer of the electrophotographic member according to one aspect of the present disclosure.

FIGS. 3A and 3B are diagrams illustrating deformation of the elastic layer according to the present disclosure.

FIG. 4 is a diagram illustrating cutting positions and directions of a cross section.

FIG. 5 is a schematic view showing a method for producing an electrophotographic member according to one embodiment of the present disclosure.

FIG. 6 is a schematic cross-sectional view of an example of an image forming apparatus according to one embodiment of the present disclosure.

FIG. 7 is a schematic cross-sectional view of an example of a process cartridge according to one embodiment of the present disclosure.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ.

The inventors speculate that the reason why deformation recovery of the conductive member for electrophotographic instruments disclosed in Japanese Patent Application Publication No. 2017-116685 is insufficient is as follows. That is, low hardness and low sagging characteristics of the conductive member for electrophotographic instruments disclosed in Japanese Patent Application Publication No. 2017-116685 are achieved by separating functions of the components of the conductive elastic layer into a conductive phase and a flexible phase (paragraph 0030 in Japanese Patent Application Publication No. 2017-116685, etc.). Here, the conductive phase and the flexible phase are formed by phase separation of two types of polymers that are incompatible with each other. Therefore, there is no chemical bond between the conductive phase and the flexible phase. Therefore, it is considered that the recovery behavior from deformation of the conductive elastic layer when a load is applied to the conductive elastic layer and the load is then removed occurs independently in the conductive phase and the flexible phase. This is speculated as one of the reasons why the recovery from deformation of the conductive elastic layer is insufficient. Based on this consideration, the inventors conducted further studies, and as a result, found that a urethane elastomer having a specific structure can achieve both flexibility and recovery from deformation to a very high level even if it contains a conductive filler.

Hereinafter, an electrophotographic member according to a preferable embodiment of the present disclosure and the like will be described in detail.

### <Electrophotographic Member>

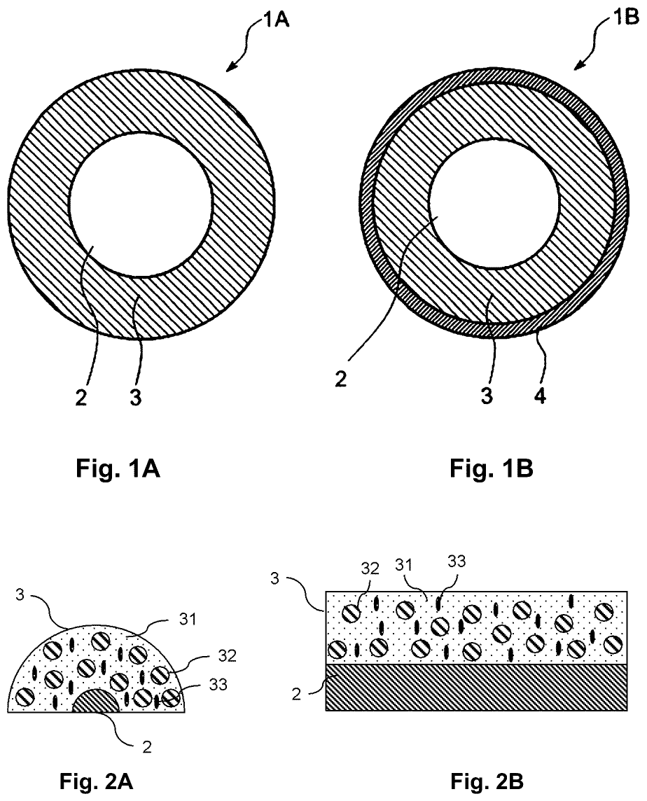

FIG. 1A and FIG. 1B are schematic cross-sectional views of two aspects of an electrophotographic member having a roller shape (hereinafter referred to as an “electrophotographic roller”) in a circumferential direction according to the present disclosure.

An electrophotographic roller 1A shown in FIG. 1A includes a conductive shaft core 2 and a conductive elastic layer 3 (hereinafter simply referred to as an “elastic layer”) that covers the surface (outer circumferential surface) of the shaft core 2. In addition, an electrophotographic roller 1B shown in FIG. 1B additionally has a surface layer 4 on the surface (hereinafter referred to as an “outer surface”) of the elastic layer 3 on the side opposite to the side that faces the shaft core 2. Here, the electrophotographic roller according to the present disclosure is not limited to these configurations, and may have, for example, an adhesive layer (not shown) between respective layers.

### (Shaft Core)

The shaft core 2 preferably has conductivity in order to supply power to the surface of the electrophotographic member through the shaft core. The shaft core preferably has a lower electrical resistance value than the elastic layer, and the volume resistivity of the shaft core is preferably 10³ Ω·cm or less.

The conductive shaft core that is appropriately selected from among those known in the field of electrophotographic members can be used, and one made of a metal such as aluminum, aluminum alloy, stainless steel, or iron is preferable. In addition, in order to improve corrosion resistance and abrasion resistance, these metals may be plated with chromium, nickel or the like.

The shape of the shaft core may be any shape selected from among a hollow (cylindrical) shape and a solid (columnar) shape. For example, a columnar shaft core having a carbon steel alloy surface plated with nickel to a thickness of about 5 μm can be used. The outer diameter of the cylindrical or columnar shaft core can be appropriately selected depending on an image forming apparatus on which it is mounted.

### (Elastic Layer)

The elastic layer 3 satisfies the following requirements (1-1) to (1-4).
Requirement (1-1): The elastic layer contains a urethane elastomer and a conductive filler, and the urethane elastomer contains a matrix and a plurality of domains dispersed in the matrix.
Requirement (1-2): The relationship between the parameter A indicating the viscoelasticity term of the domain and the parameter B indicating the viscoelasticity term of the matrix, which are measured in a viscoelasticity image of a cross section of the elastic layer in which the domain and the matrix are exposed under a scanning probe microscope, satisfies A<B.
Requirement (1-3): The micro rubber hardness of the elastic layer at a temperature of 23° C. is 20 to 50.
Requirement (1-4): When a Vickers indenter is brought into contact with the matrix on the outer surface of the elastic layer at a temperature of 23° C., the Vickers indenter is pressed into the elastic layer at a load rate of 10 mN/30 seconds, a load of 10 mN is maintained for 60 seconds, and the load is then removed, the strain 5 seconds after unloading is 1.00 μm or less.

In a urethane elastomer, the matrix is mainly responsible for a function that allows the urethane elastomer to exhibit fast recovery from deformation, and the domain is mainly responsible for a function that allows the urethane elastomer to have a low hardness. In addition, as will be described below, in the urethane elastomer according to the present disclosure, it is considered that the domain and the matrix are chemically bonded via a urethane bond at the boundary part between the domain and the matrix. Therefore, it is considered that, when a load applied to the urethane elastomer is removed, the recovery of the domain from deformation proceeds in linkage with the recovery of the matrix from deformation. Therefore, the elastic layer according to the present disclosure is thought to have very fast recovery from deformation. When such an elastic layer is used, the elastic layer exhibits softness required by the requirement (1-3) and a very fast recovery from deformation required by the requirement (1-4).

Here, in general urethane elastomers, there is a difference in elastic modulus between a so-called hard segment and soft segment. However, in general urethane elastomers, the soft segment constitutes the matrix, and the hard segment constitutes the domain, and the elastomers are thought to have flexibility required by the requirement (1-3) but not to exhibit a fast recovery rate from deformation required by the requirement (1-4).

FIG. 2A is a partial cross-sectional view of an electrophotographic roller 1A in the circumferential direction according to one aspect of the present disclosure. In addition, FIG. 2B is a partial cross-sectional view along the longitudinal direction of the shaft core 2 of the electrophotographic roller 1A.

FIG. 2A and FIG. 2B schematically show a matrix 31 and a plurality of domains 32 dispersed in the matrix 31 of a urethane elastomer, and a conductive filler 33 contained in the elastic layer, which are observed in a cross section of the elastic layer 3 in the thickness direction.

As described above, the urethane elastomer contains the matrix 31 and the plurality of domains 32 dispersed in the matrix. Thus, the matrix exhibits higher elasticity than the domain.

In addition, it is preferable that at least a part of the outer surface of the elastic layer be formed of a matrix. In the electrophotographic roller shown in FIG. 2A and FIG. 2B, an example in which the entire outer surface of the elastic layer 3 is formed of a matrix is shown.

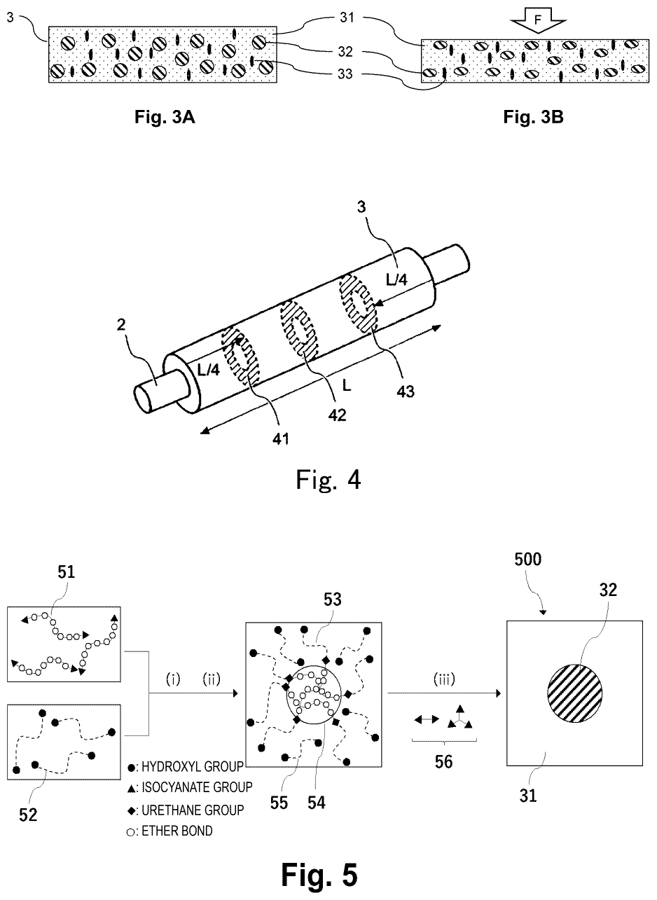

FIG. 3A and FIG. 3B are diagrams illustrating recovery of the elastic layer 3 from deformation according to the present disclosure. As shown in FIG. 3A, the plurality of domains 32 are dispersed in the matrix 31. Thus, since the domain 32 has lower elasticity than the matrix 31, as shown in FIG. 3B, when the elastic layer 3 is compressed in the direction of the arrow F, the domain 32 deforms preferentially. Therefore, even if the matrix 31 has high elasticity, the micro rubber hardness of the elastic layer can be reduced. In addition, when the compressed elastic layer is released, the thickness of the elastic layer can be quickly returned to the thickness before compression due to the elasticity of the matrix 31 in a continuous phase. That is, the matrix 31 exhibits fast recovery from deformation.

### (Micro Rubber Hardness of Elastic Layer)

The micro rubber hardness of the elastic layer at a temperature of 23° C. is 20 to 50 degrees. When the micro rubber hardness is 50 degrees or less, the nip width between the developing roller and the toner control member and the nip width between the charging roller and the photosensitive member increase, and the contact pressure does not become excessively large. This makes it unlikely for the toner on the developing roller to melt adhesion on the developing roller and for the toner that has slipped through the cleaning member and adhered to the charging roller to melt adhesion on the charging roller. In addition, when the micro rubber hardness is 20 degrees or more, the mechanical strength increases, and the ends of the elastic layer are less likely to be scraped off even when used in a long-lifespan image forming apparatus. The micro rubber hardness is preferably 20 to 40 degrees and more preferably 22 to 38 degrees.

The micro rubber hardness can be adjusted, for example, by the elastic modulus of the matrix, the amount of the conductive filler contained in the matrix, the ratio of the matrix to the domain, or the like. Specifically, for example, increasing the elastic modulus of the matrix, increasing the proportion of the conductive filler contained in the matrix, and decreasing the ratio (volume) of the domain to the matrix act in the direction in which the micro rubber hardness increases.

The micro rubber hardness can be determined, for example, as follows. Regarding the location for measuring the micro rubber hardness, when the length of the elastic layer in a longitudinal direction is L, a total of three locations including the center of the elastic layer in the longitudinal direction and two locations of L/4 from both ends of the elastic layer toward the center are used. At each measurement location, the micro rubber hardness of the surface is measured using a micro rubber hardness meter (product name: MD-1capa; commercially available from Kobunshi Keiki Co., Ltd., push needle: type A (push pin shape: cylindrical, a diameter of 0.16 mm, a height of 0.5 mm, a pressure leg size: an outer diameter of 4 mm, an inner diameter of 1.5 mm), measurement mode: a peak hold mode) at a temperature of 23° C.

### (Parameter Indicating Viscoelasticity Term)

The matrix 31 and the domain 32 have a relationship between the parameter A indicating the viscoelasticity term of the domain and the parameter B indicating the viscoelasticity term of the matrix, which is measured in a viscoelasticity image under a scanning probe microscope, satisfies A<B.

The parameters A and B can be determined by preparing a section from the elastic layer and measuring the section under a scanning probe microscope (SPM/AFM). As the scanning probe microscope, for example, “S-Image” (product name, commercially available from Hitachi High-Tech Science Corporation) can be used.

In addition, examples of sectioning units include a sharp razor, a microtome, and a focused ion beam (FIB), and a microtome is used in the present disclosure.

The locations for preparing sections are a total of three locations including the center of the elastic layer in the longitudinal direction and two locations of L/4 from both ends of the elastic layer toward the center when the length of the elastic layer in a longitudinal direction is L. Thus, as shown in FIG. 4, a total of three sections are prepared from cross sections 41 to 43 of the elastic layer in the thickness direction. As a result, the obtained section has a cross section in which the domain and the matrix are exposed.

In addition, the region of the electrophotographic member that deforms when it comes into contact with another member is mainly a thickness region from the outer surface of the elastic layer to a position of a depth of 100 μm. Therefore, the observation region is a thickness region from the surface of the elastic layer to a position of a depth of 100 μm. Specifically, regarding the observation regions of the cross sections 41 to 43, square observation regions with a side of 50 μm in the thickness region from the outer surface of each section to a position of a depth of 100 μm are selected, and viscoelasticity images are observed in a total of three observation regions.

The measurement mode for the viscoelasticity image taken by SPM is a micro viscoelastic dynamic force mode (VE-DFM). In addition, as the cantilever, a silicon microcantilever for DFM (“SI-DF3” (product name), commercially available from Hitachi High-Tech Science Corporation, spring constant=1.9 N/m) is used. In addition, the scanning frequency is 0.5 Hz.

Here, VE-DFM is one of the measurement modes of the scanning probe microscope (SPM). In VE-DFM, an image of the surface shape can be obtained which controlling the distance between the probe and the measurement sample so that the vibration and amplitude of the cantilever are constant while the cantilever is resonating. In addition, in VF-DFM, the viscoelasticity distribution can be imaged from the deflection amplitude of the cantilever when a periodic force is applied by micro-vibrating the sample in the Z direction. When the sample is hard, the sample deformation is small, and the cantilever amplitude is large, and when the sample is soft, the sample deformation vibration is induced, and the cantilever amplitude is small.

The obtained amplitude is converted into displacement in mV, which becomes the parameter indicating the viscoelasticity term. Therefore, the parameter A and the parameter B are indexes indicating the relationship between the hardness of the domain and the hardness of the matrix present in one observation sample. Here, in VF-DFM, the magnitude of the amplitude of the cantilever is output as a voltage, and thus the units of the parameter A and the parameter B are mV. In addition, a larger value indicates higher elasticity.

After the viscoelasticity image is obtained, in each observation region, the parameters indicating the viscoelasticity term are obtained for 10 points each for the matrix and the domain, and their arithmetic average values are taken as the parameter A indicating the viscoelasticity term of the domain and the parameter B indicating the viscoelasticity term of the matrix. The measurement procedure will be described below.

The ratio (A/B) of the parameter A (mV) to the parameter B (mV) is preferably 0.65 or less, more preferably 0.60 or less, still more preferably 0.50 or less. When the A/B is smaller, since the difference in viscoelasticity between the matrix and the domain is larger, it becomes easier to achieve both hardness and recovery from deformation. The lower limit of A/B is not particularly limited, and a smaller value is more preferable. Specifically, for example, it is 0.10. The preferable range of A/B is, for example, from 0.10 to 0.65, from 0.10 to 0.60, from 0.10 to 0.50 or less, particularly from 0.10 to 0.40, and further, from 0.10 to 0.30.

The parameters A and B can be adjusted, for example, by the elastic modulus of the domain and the matrix. The elastic modulus of the matrix can be increased by, for example, increasing the crosslink density of the matrix using a polyisocyanate trimeric compound or polymeric compound as a matrix-forming raw material. Regarding the elastic modulus of the domain, for example, by increasing the molecular weight of the polyether polyol as a domain-forming raw material, the crosslink density of the domain decreases, and the elastic modulus decreases.

(Recovery from Deformation)

For the elastic layer 3, when a Vickers indenter is brought into contact with the matrix on the outer surface of the elastic layer at a temperature of 23° C., the Vickers indenter is pressed into the elastic layer at a load rate of 10 mN/30 seconds, a load of 10 mN is maintained for 60 seconds, and the load is then removed, the strain 5 seconds after unloading is 1.00 μm or less.

When the strain 5 seconds after unloading measured under the above conditions is 1.00 μm or less, it is possible to curb streaky image defects when applied as a developing roller in a high-speed printer. This is because the deformation of the developing roller can be recovered to a size equal to or smaller than that of a single normal toner particle in a short time from when the high-speed printer operates until an electrostatic latent image develops. In addition, even when applied to a charging roller, since the recovery from deformation is fast, uneven discharging to the photosensitive member is unlikely to occur, and it is possible to prevent the occurrence of streaky image defects due to uneven charging of the photosensitive member. As described above, in the elastic layer according to the present disclosure, it is considered that the domain and the matrix are chemically bonded via a urethane bond at the boundary part between the domain and the matrix. Therefore, it is considered that the recovery of the domain from deformation when the load applied to the urethane elastomer is removed is linked to the recovery of the matrix from deformation. Therefore, it is considered that the elastic layer according to the present disclosure has very fast recovery from deformation, and the strain 5 seconds after unloading can be kept within the above range.

The strain 5 seconds after unloading can be adjusted, for example, by the elastic modulus of the matrix, assuming that the matrix and the domain are chemically bonded. Specifically, for example, by increasing the crosslink density of the matrix of the urethane elastomer using a polyisocyanate trimeric compound or polymeric compound as at least one of raw materials of the urethane elastomer, the elastic modulus of the matrix can be increased.

The strain 5 seconds after unloading is preferably 0.90 μm or less and more preferably 0.80 μm or less. In addition, the lower limit of the strain 5 seconds after unloading is not particularly limited, and is generally 0.00 μm, and may be 0.05 μm, or 0.10 μm. For example, it is preferably 0.00 to 1.00 μm, 0.00 to 0.90 μm, or 0.00 to 0.80 μm.

Here, the value of the strain 5 seconds after unloading is a value obtained by an indentation test using a micro hardness tester (nanoindenter). The measurement temperature is a temperature of 23° C. In addition, the indenter used for measurement is a Vickers indenter with a square pyramid shape and a facing angle of 136°. In the measurement method, a Vickers indenter is brought into contact with a matrix part on the surface of the elastic layer, the Vickers indenter is pressed into the elastic layer at a load rate of 10 mN/30 seconds, and a load of 10 mN is maintained for 60 seconds. Next, the load is removed (unloading) at an unload rate of 10 mN/1 sec, and the strain of the elastic layer 5 seconds after unloading is measured. In addition, when the length of the elastic layer in a longitudinal direction is L, the measurement positions are a total of three locations including the center of the elastic layer in the longitudinal direction and two locations of L/4 from both ends of the elastic layer toward the center.

### (Elastic Modulus of Matrix)

The elastic modulus of the matrix 31 present in the observation region at a temperature of 23° C. is preferably 1 to 13 MPa. When the elastic modulus of the matrix is 1 MPa or more, the spring effect of the matrix becomes large, and the recovery from deformation can be made faster. In addition, when the elastic modulus of the matrix is 13 MPa or less, the hardness of the matrix decreases and the micro rubber hardness of the elastic layer can be kept lower. In addition, when the elastic modulus of the matrix 31 is 2 MPa or more, this is more preferable because the spring effect of the matrix further increases, and the recovery from deformation can be made faster. In addition, when the elastic modulus of the matrix is 8 MPa or less, this is more preferable because the hardness of the matrix further decreases, and the micro rubber hardness of the elastic layer can be kept lower. As a result, it is easy to prevent image defects and scraping of the ends due to toner melt adhesion. That is, the elastic modulus of the matrix is more preferably 2 to 8 MPa and still more preferably 5 to 8 MPa.

The elastic modulus of the matrix can be adjusted by, for example, a method for increasing the crosslink density using a polyisocyanate trimeric compound or polymeric compound. Generally, when the elastic modulus increases, the micro rubber hardness of the elastic layer also increases, but in the present disclosure, since a plurality of low-elasticity domains are dispersed in the matrix, an excess increase in the hardness can be reduced.

The elastic modulus of the matrix can be calculated by preparing a section of the elastic layer and measuring the section under a scanning probe microscope (SPM/AFM). As the scanning probe microscope, for example, “MFP-3D-Origin” (product name, commercially available from Oxford Instruments) can be used.

In addition, examples of sectioning units include a sharp razor, a microtome, and a focused ion beam (FIB).

The locations for preparing sections are a total of three locations including the center of the elastic layer in the longitudinal direction and two locations of L/4 from both ends of the elastic layer toward the center when the length of the elastic layer in a longitudinal direction is L. Thus, as shown in FIG. 4, a total of three sections are prepared from cross sections 41 to 43 of the elastic layer in the thickness direction. As a result, the obtained section has a cross section in which the domain and the matrix are exposed.

In addition, for the same reason as in the measurement of the parameter indicating the viscoelasticity term, regarding the observation regions of the cross sections 41 to 43, arbitrary observation regions of 50 μm squares in the region corresponding to the thickness region from the outer surface of each section to a depth of 100 μm are selected, and phase images are observed in a total of three observation regions.

The measurement mode for the phase image taken by SPM is AM-AFM. In addition, as the cantilever, a silicon cantilever for dynamic mode, for example, “OMCL-AC-160TS” (product name, commercially available from Olympus Corporation, spring constant=47.08 N/m) is used. In addition, the scanning frequency is 0.5 Hz.

After a phase image is obtained, a force curve is measured using an SPM in order to measure the elastic modulus of the matrix. The force curve measurement mode is a contact mode, Force Distance is 500 nm, and Trigger Point is 0.01 V. In addition, as the cantilever, similarly to the above, a silicon cantilever for dynamic mode, for example, “OMCL-AC-160TS” (product name, commercially available from Olympus Corporation, spring constant-47.08 N/m) is used. The scanning frequency is 1 Hz.

The elastic modulus of the matrix is calculated at 10 points in each of three observation regions, for a total of 30 points, and the arithmetic average value thereof is taken as the elastic modulus of the matrix.

### (Conductive Filler Contained in Matrix)

The elastic layer contains a conductive filler. The conductive filler is preferably predominantly distributed in the matrix. That is, the matrix preferably contains the conductive filler.

In the electrophotographic member, the elastic layer is required to have a low electrical resistance. If the electrical resistance is not sufficiently low, image defects such as a low density occur in solid images. In the elastic layer, when the matrix contains a conductive filler, an elastic layer with a low electrical resistance is easily realized. In addition, when the conductive filler is predominantly distributed in the matrix, it is easier for the domain to exhibit a function of curbing an increase in the micro rubber hardness.

The conductive filler can be used without particular limitation as long as it exhibits conductivity. Examples thereof include solid carbon materials such as carbon black, graphite, carbon nanotubes, fullerene, graphene, and carbon nanowalls; metal powders such as silver, copper, aluminum, nickel, and iron; conductive metal oxides such as conductive tin oxides and conductive titanium oxides; and inorganic ionic substances such as lithium perchlorate, sodium perchlorate, and calcium chlorate. These may be used alone or two or more thereof may be used in combination.

Among these, solid carbon materials such as carbon black, graphite, carbon nanotubes, fullerene, graphene, and carbon nanowalls are preferable because conductivity can be imparted by adding a small amount thereof.

More preferably, conductive carbon blacks such as furnace black, thermal black, acetylene black, ketjen black, polyacrylonitrile (PAN)-based carbon, and pitch-based carbon are preferable because it is easy to adjust the resistance to a desired range by appropriately selecting the particle size, the structure or the like. In addition, carbon nanotubes are preferable because conductivity can be imparted by adding a very small amount thereof.

Preferable examples of conductive carbon black include Denka Black (commercially available from Denka Co., Ltd.), Ketchen black series (commercially available from Lion Corporation), and NIPex 160IQ (commercially available from Orion Engineered Carbons). Examples of Ketchen black series include ketjen black EC600JD, ketjen black EC300J, carbon ECP, and carbon ECP600JD.

Here, the mechanism by which carbon black exhibits conductivity is explained by the percolation theory, and when the carbon black filling rate is low, the electrical conductivity does not change, but when the filling rate exceeds a certain critical filling rate, carbon black forms conductive paths arranged at certain intervals or shorter, a rapid increase in electrical conductivity (a decrease in volume resistivity) occurs, and the electrical conductivity then tends to reach a certain value.

In addition, in addition to the conductive filler, an ion conducting agent can also be used in the elastic layer in order to adjust the electrical resistance. As the ion conducting agent, an ion conducting agent that can be used in a surface layer to be described below can be used.

### (Proportion of Conductive Filler Contained in Matrix)

The proportion of the conductive filler 33 contained in the matrix observed in a cross section of the elastic layer in the thickness direction will be described below. The proportion of the conductive filler contained in the matrix means the proportion of the area of the conductive filler contained in the matrix relative to the total area of the conductive filler present in an observation region to be described below.

The proportion of the conductive filler contained in the matrix can be calculated by preparing a section of the elastic layer and measuring the section under a scanning electron microscope. As the scanning electron microscope, for example, “Helios” (product name, commercially available from Thermo Fisher Scientific) can be used. In addition, a transmission electron microscope (TEM) or a scanning probe microscope (SPM/AFM) can be used for measurement.

In addition, examples of sectioning devices include a sharp razor, a microtome, and a focused ion beam (FIB). Among the above devices, an ultramicrotome that can prepare ultrathin sections can be particularly suitably used.

The locations for preparing sections are a total of three locations including the center of the elastic layer in the longitudinal direction and two locations of L/4 from both ends of the elastic layer toward the center when the length of the elastic layer in a longitudinal direction is L. Thus, as shown in FIG. 4, a total of three sections are prepared from the cross sections 41 to 43 of the elastic layer in the thickness direction. As a result, the obtained section has a cross section in which the domain and the matrix are exposed.

In addition, for the same reason as in the measurement of the parameter indicating the viscoelasticity term, regarding the observation regions of the cross sections 41 to 43, a square observation region with a side of 50 μm square is a thickness region from the outer surface of each section to a position of a depth of 100 μm, and the proportion of the conductive filler contained in the matrix is calculated in a total of three observation regions. A detailed calculation method will be described below.

That is, when the length of the elastic layer in a longitudinal direction is L, at a total of three locations including the center of the elastic layer in the longitudinal direction and two locations of L/4 from both ends of the elastic layer toward the center, for each cross section of the elastic layer in the thickness direction in which the domain and the matrix are exposed, if a square observation region with a side of 50 μm is a thickness region from the outer surface of the elastic layer to a position of a depth of 100 μm, it is preferable that each observation region satisfy the requirement (3). Requirement (3): The proportion of the area of the conductive filler contained in the matrix present in the observation region relative to the total area of the conductive filler present in the observation region is 95% or more.

The proportion of the area of the conductive filler contained in the matrix may be 85% or more or 90% or more. In addition, the upper limit of the proportion of the conductive filler contained in the matrix is not particularly limited, and may be 100% or 99%. For example, it is preferably 85 to 100%, 90 to 100%, or 95 to 100%.

When the proportion of the conductive filler contained in the matrix is within the above range, it is possible to prevent the hardness of the domain from increasing, and to achieve both low micro rubber hardness and fast recovery from deformation.

Regarding the proportion of the conductive filler contained in the matrix, when a dispersion is prepared in a step (ii) to be described below, the interface between the matrix and the domain is strongly phase-separated by the urethane reactive emulsifier, and thus even if a conductive filler is added after the step (ii), it is possible to curb a large amount of the conductive filler entering the domain, and it is possible to increase the proportion of the conductive filler contained in the matrix. In addition, when the dispersibility of the conductive filler and the matrix material used is improved, the proportion of the conductive filler contained in the matrix can increase. In addition, the proportion of the conductive filler contained in the matrix can decrease when the dispersibility of the conductive filler and the domain material used is improved. Specifically, when the amount of hydrophilic functional groups on the surface of the conductive filler decreases, the proportion of the conductive filler contained in the matrix can increase. In addition, when the amount of hydrophilic functional groups on the surface of the conductive filler increases, the proportion of the conductive filler contained in the matrix can decrease.

The content of the conductive filler in the elastic layer based on the mass of the elastic layer is preferably 0.02 to 5.0 mass %. When the content of the conductive filler is 0.02 mass % or more, the conductivity of the elastic layer becomes better. In addition, when the content of the conductive filler is 5.0 mass % or less, it is easy to achieve both conductivity, a low hardness, and a low compression set.

The content of the conductive filler is more preferably 0.05 to 4.5 mass % and still more preferably 0.1 to 4.0 mass %.

Specifically, in the case of carbon black having a specific surface area of less than 500 m²/g (for example, Denka Black (commercially available from Denka Co., Ltd.)), the content is preferably 1.0 to 4.5 mass %, and more preferably 1.5 to 4.0 mass %. In the case of carbon black having a specific surface area of 500 m²/g or more (for example, Ketchen black series, commercially available from Lion Corporation), the content is preferably 0.2 to 4.0 mass %, and more preferably 0.5 to 3.5 mass %. In addition, in the case of tube-shaped carbon fibers (carbon nanotubes) or needle-shaped carbon fibers (carbon nanofibers) (for example, single-walled carbon nanotubes (TUBALL (registered trademark)), commercially available from OCSiAl Corporation) having a specific surface area of 500 m²/g or more, the content is preferably 0.05 to 3.0 mass %, and more preferably 0.1 to 2.5 mass %.

When the conductive filler is a solid carbon material, the content thereof can be calculated using a thermogravimetric-differential thermal analysis device (TG-DTA).

Specifically, the content is measured by the following procedure.

Using TG-DTA, a sample in a predetermined container is heated to 600° C. at a heating rate of 10° C./min in a nitrogen atmosphere, held for 10 minutes, and then cooled to 400° C. at a cooling rate of 10° C./min, and a weight reduction proportion W1(%) from when measurement starts is measured. Next, the sample is heated again to 800° C. at a heating rate of 10° C./min in an air atmosphere, and a weight reduction proportion W2(%) from when measurement starts is measured. The content of the conductive filler (solid carbon material) can be calculated as the difference between W2 and W1 (W2-W1(%)).

### (Cross-Sectional Area and Number of Domains)

The cross-sectional area and number of domains 32 of the urethane elastomer observed in a cross section of the elastic layer in the thickness direction will be described.

When the length of the elastic layer in a longitudinal direction is L, at a total of three locations including the center of the elastic layer in the longitudinal direction and two locations of L/4 from both ends of the elastic layer toward the center, for each cross section of the elastic layer in the thickness direction in which the domain and the matrix are exposed, if a square observation region with a side of 50 μm is a thickness region from the outer surface of the elastic layer to a position of a depth of 100 μm, it is preferable that each observation region satisfy the following requirement (2-1) and requirement (2-2).
Requirement (2-1): The proportion of the total cross-sectional area of the domains present in the observation region is 15 to 45 area % of the area of the observation region.
Requirement (2-2): Among the domains present in the observation region, the proportion of the number of domains having a cross-sectional area of 0.1 to 13.0 area % relative to the area of the observation region is 70% or more.

Regarding the requirement (2-1), when the proportion of the total cross-sectional area of the domains present in the observation region is 15 area % or more, the micro rubber hardness of the elastic layer can be kept lower. In addition, when the proportion of the total cross-sectional area of the domains is 45 area % or less, the recovery of the elastic layer from deformation can be made faster.

In addition, the proportion of the total cross-sectional area of the domains present in the observation region is more preferably 20 to 40 area % and still more preferably 25 to 35 area %.

For example, when the matrix has a polycarbonate structure represented by Formula (1), and the domain has a polyether structure represented by Formula (2), the proportion of the total cross-sectional area of the domains can be adjusted by changing the content proportions of the polycarbonate structure (represented by Formula (1)) contained in the matrix and the polyether structure (represented by Formula (2)) contained in domain. For example, when the content proportion of the polyether structure represented by Formula (2) increases, the proportion of the total cross-sectional area of the domains increases. In addition, when the content proportion of the polyether structure represented by Formula (2) is within the above range, the matrix and the domain are less likely to be reversed, and the polyether structure represented by Formula (2) is less likely to become the main component of the matrix.

In addition, the cross-sectional area of the domain can be increased, for example, by increasing the number average molecular weight of the polyether polyol that forms the polyether structure represented by Formula (2).

Regarding the requirement (2-2), when the proportion of the number of domains having a cross-sectional area of 0.1 to 13.0 area % relative to the area of the observation region is 70% or more of the total number of domains in the observation region, a number of domains large enough to be deformed sufficiently when the elastic layer is pressed against is secured. Therefore, the micro rubber hardness of the elastic layer can be made lower. In addition, since the number of large domains that deform excessively when a load is applied to the elastic layer is small, it is possible to curb the micro rubber hardness of the elastic layer becoming too low.

In addition, the proportion of the number of domains having a cross-sectional area of 0.1 to 13.0 area % relative to the area of the observation region is preferably 70 to 100%, more preferably 80 to 100%, and still more preferably 90 to 100%.

The proportion of the number of domains having a cross-sectional area of 0.1 to 13.0 area % relative to the area of the observation region can be adjusted by the size of the cross-sectional area of the domain. The proportion of the number of domains satisfying the above requirement is higher as the size of the cross-sectional area of the domain is closer to the center of the range of the above requirement. As described above, the size of the cross-sectional area of the domain can be adjusted by the number average molecular weight of the polyether polyol that forms the polyether structure represented by Formula (2), and increases when the number average molecular weight of the polyether polyol increases. In addition, the cross-sectional area of the domain is reduced by increasing the isocyanate index in the step of obtaining a first polyether to be described below and increasing the shear force when materials are mixed.

The proportion of the total cross-sectional area of the domains present in the observation region and the proportion of the number of domains having a cross-sectional area of 0.1 to 13.0 area % relative to the area of the observation region can be measured according to the method for obtaining the proportion of the conductive filler contained in the matrix in the previous section, and details will be described below.

In addition, the average cross-sectional area of the domains present in the observation region relative to the area of the observation region is preferably 0.08 to 16.00 area %, more preferably 0.10 to 15.00 area %, and still more preferably 0.10 to 13.00 area %.

Within the above range, it becomes easily to adjust the proportion of the number of domains having a cross-sectional area of 0.10 to 13.00 area % relative to the area of the observation region.

As described above, the average cross-sectional area of the domains can be adjusted by the number average molecular weight of the polyether polyol that forms the polyether structure represented by Formula (2), and increases when the number average molecular weight of the polyether polyol increases. In addition, the average cross-sectional area of the domains is reduced by increasing the isocyanate index in the step of obtaining a first polyether to be described below and increasing the shear force when materials are mixed.

### (Circularity of Domain)

For the domain of the urethane elastomer observed in a cross section of the elastic layer in the thickness direction in which the domain and the matrix are exposed, when the proportion of the number of domains with a circularity of 0.60 to 0.95 in the observation region is preferably 70% or more, more preferably 80% or more, and still more preferably 90% or more. In addition, the upper limit may be 100% or less or 98% or less. For example, it is preferably 70 to 98%, 80 to 100%, or 90 to 100%.

In the domains having a circularity within the above range, when the domains recover from deformation, anisotropy is unlikely to occur in a direction in which the domain shape recovers. Thus, when the number (proportion) of domains having a circularity within the above range increases, the recovery of the elastic layer from deformation is less likely to be anisotropic. In other words, an elastic layer can be made to recover from deformation more isotropically. As a result, wrinkles and the like due to anisotropy in the recovery from deformation are unlikely to occur in the elastic layer after recovery from deformation. Here, when wrinkles or the occur, circumferential streaky image defects may occur randomly in the longitudinal direction according to the positions of the wrinkles.

The circularity of the domain and the proportion of the number of domains can be measured by methods to be described below.

The proportion of the number of domains with a circularity of 0.60 to 0.95 can be adjusted, for example, by the speed at which the material is injected into the mold. When the injection speed is low, the shear force applied to the material is also reduced, and thermal curing can be performed while maintaining a high circularity.

When the length of the elastic layer in a longitudinal direction is L, at a total of three locations including the center of the elastic layer in the longitudinal direction and two locations of L/4 from both ends of the elastic layer toward the center, for each cross section of the elastic layer in the thickness direction in which the domain and the matrix are exposed, if a square observation region with a side of 50 μm is a thickness region from the outer surface of the elastic layer to a position of a depth of 100 μm, the average circularity of the domains present in the observation region is preferably 0.55 to 1.00. In addition, it is more preferably 0.60 to 0.98 and still more preferably 0.60 to 0.95.

Within the above range, it becomes easy to adjust the proportion of the number of domains with a circularity of 0.60 to 0.95 to be within the above range.

The average circularity of the domains can be adjusted, for example, by the speed at which the material is injected into the mold. When the injection speed is low, the shear force applied to the material is also reduced, and thermal curing can be performed while maintaining a high circularity.

### (Material of Elastic Layer)

The urethane elastomer will be described. As described above, the elastic layer contains a urethane elastomer and a conductive filler, and the urethane elastomer contains the matrix 31 and the plurality of domains 32 dispersed in the matrix. That is, the urethane elastomer has a matrix-domain structure.

In this case, it is preferable that the matrix 31 have a structure that can improve recovery from deformation and the domain 32 have a structure that contributes to curbing an increase in the micro rubber hardness.

The fact that the elastic layer contains a urethane elastomer can be determined by analysis using, for example, a spectroscopic analyzer such as a microscopic infrared spectroscopic analyzer or a mass spectrometer.

The matrix 31 preferably has a polycarbonate structure represented by the following Formula (1).

A polyurethane obtained by reacting a polyol having a polycarbonate structure (polycarbonate polyol) with a polyisocyanate exhibits high elasticity due to the strong intermolecular force between carbonate groups. Therefore, it is preferable as a structure to be contained in the matrix. The matrix has at least one polycarbonate structure represented by Formula (1) and preferably has a plurality of polycarbonate structures. When the matrix has a plurality of polycarbonate structures represented by Formula (1), the polycarbonate structures can be repeating structure units.

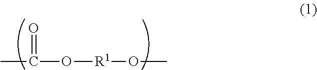

(in Formula (1), R¹ is an alkylene group having 3 to 9 (preferably 3 to 6) carbon atoms).

An alkylene group having 3 to 9 carbon atoms represented by R¹ in Formula (1) may have a linear structure or a branched structure, and more preferably has a branched structure.

When R¹ is an alkylene group having 3 to 9 carbon atoms, the incompatibility with the domain having a polyether structure represented by the following Formula (2) to be described below is secured, and the matrix and the domain can be clearly phase-separated. Therefore, the urethane elastomer can more reliably exhibit two functions of softness and fast recovery from deformation.

In addition, when R¹ is an alkylene group having a branched structure and having 3 to 9 (preferably 4 to 9) carbon atoms, it is possible to appropriately reduce the intermolecular force between carbonate groups and it is possible to curb the elasticity of the matrix becoming excessively high.

Examples of R¹'s include —(CH₂)ₘ— (m=3 to 9, preferably 3 to 6), —CH₂C(CH₃)₂CH₂—, —CH₂CH(CH₃)CH₂—, and —(CH₂)₂CH(CH₃)(CH₂)₂—. These may be used alone or two or more thereof may be used in combination.

The fact that the matrix has a polycarbonate structure represented by Formula (1) and R¹ is an alkylene group having 3 to 9 carbon atoms can be determined by analysis using, for example, a spectroscopic analyzer such as a microscopic infrared spectroscopic analyzer or a mass spectrometer.

The domain 32 preferably has a polyether structure represented by the following Formula (2). Polyether exhibits a low elastic modulus due to the weak intermolecular force between ether groups. Therefore, it is preferable as a structure to be contained in the domain. The domain has at least one polyether structure represented by Formula (2) and preferably has a plurality of polyether structures. When the domain has a plurality of polyether structures represented by Formula (2), the polyether structures can be repeating structure units.

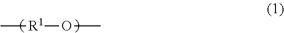

(in Formula (2), R² is an alkylene group having 3 to 5 (preferably 4 to 5) carbon atoms).

An alkylene group having 3 to 5 carbon atoms represented by R² in Formula (2) may have a linear structure or a branched structure, and preferably has a branched structure.

When R² is an alkylene group having 3 to 5 carbon atoms, the incompatibility with the matrix having a polycarbonate structure represented by Formula (1) is secured, and the matrix and the domain can be clearly phase-separated. Therefore, the urethane elastomer can more reliably exhibit two functions of softness and fast recovery from deformation.

In addition, when R² is an alkylene group having a branched structure and having 3 to 5 (preferably 4 to 5) carbon atoms, it is possible to curb crystallization of the domain and it is possible to more easily reduce the hardness of the domain. As a result, the domain tends to have a low elastic modulus.

Examples of R²'s include —(CH₂)ₘ— (m=3 to 5, preferably 4 to 5), —CH₂CH(CH₃)—, —CH₂C(CH₃)₂CH₂—, —CH₂CH(CH₃)CH₂—, and —(CH₂)₂CH(CH₃)CH₂—. These may be used alone or two or more thereof may be used in combination.

The fact that the domain has a polyether structure represented by Formula (2) and R² is an alkylene group having 3 to 5 carbon atoms can be determined by analysis using, for example, a spectroscopic analyzer such as a microscopic infrared spectroscopic analyzer or a mass spectrometer.

### (Method for Producing Urethane Elastomer)

As an example of a method for producing the urethane elastomer, a method including the following steps (i) to (iii) may be exemplified.
Step (i): a step of obtaining a urethane reactive emulsifier having at least two hydroxyl groups by reacting a first polyether having at least one isocyanate group with a first polycarbonate polyol having at least two hydroxyl groups.
Step (ii): a step of mixing the urethane reactive emulsifier and a second polycarbonate polyol to obtain a dispersion in which droplets containing at least a part of the urethane reactive emulsifier are dispersed in the second polycarbonate polyol.
Step (iii): a step of preparing an elastic layer-forming mixture containing the dispersion obtained in the step (ii) and a polyisocyanate having at least two isocyanate groups, and then reacting the urethane reactive emulsifier, the second polycarbonate polyol, and the polyisocyanate having at least two isocyanate groups in the elastic layer-forming mixture.

The steps of the production method will be described with reference to FIG. 5 (conductive filler (not shown)).

In the step (i), a first polyether 51 having at least one isocyanate group and a first polycarbonate polyol 52 having at least two hydroxyl groups are mixed. In the presence of a catalyst, isocyanate groups and hydroxyl groups in the mixture are reacted with each other to link them via urethane bonds, and thus a urethane reactive emulsifier 53 having at least two hydroxyl groups is obtained. The urethane reactive emulsifier is a reactive emulsifier having a urethane bond.

In the step (ii), in a second polycarbonate polyol 55, the urethane reactive emulsifier 53 obtained in the step (i) is dispersed. Here, the urethane reactive emulsifier can be mixed with the second polycarbonate polyol newly added in this step. In addition, an excess unreacted material of the first polycarbonate polyol in the step (i) can also be used as a second polycarbonate polyol.

The first polyether 51 contained in the urethane reactive emulsifier 53 is incompatible with the second polycarbonate polyol 55 and forms droplets 54.

On the other hand, the first polycarbonate polyol 52 contained in the urethane reactive emulsifier 53 is compatible with the second polycarbonate polyol 55. Therefore, droplets 54 containing the first polyether constituting a part of the urethane reactive emulsifier are uniformly and stably dispersed in the second polycarbonate polyol 55 via the first polycarbonate polyol 52. As a result, a dispersion in which the droplets 54 containing the first polyether 51 of the urethane reactive emulsifier 53 are dispersed in the second polycarbonate polyol 55 is obtained. Here, the step (i) and the step (ii) are described separately for the sake of explanation, but these steps may be a series of continuous steps.

In order to incorporate the conductive filler into the matrix, it is preferable to add and disperse the conductive filler after the step (ii). That is, the method for producing a urethane elastomer preferably includes a step of adding and dispersing a conductive filler in the dispersion obtained in the step (ii). In addition, in the step (ii), the conductive filler may be added and dispersed.

If the conductive filler is added to the second polycarbonate polyol in advance, the viscosity of the polycarbonate polyol increases due to its high intermolecular force, and the workability in the step (ii) may decrease. On the other hand, if the conductive filler is added after the step (ii), since the first polyether having a low viscosity due to its low intermolecular force is present, the viscosity does not increase excessively even if the conductive filler is added. In addition, in the step (ii), since the interface between the matrix and the domain is strongly phase-separated by the urethane reactive emulsifier, even if the conductive filler is added and stirred after the step (ii), a large amount of the conductive filler does not enter the domain.

In the step (ii), the second polycarbonate polyol 55 in which the droplets 54 are dispersed may be the unreacted material of the first polyether in the first polycarbonate polyol used in the step (i). That is, in the step (i), when an excess amount of the first polycarbonate polyol relative to the first polyether is used, it is possible to obtain a dispersion in which the urethane reactive emulsifier 53 described in the step (ii) is dispersed in an excess amount of the first polycarbonate polyol (that is, the second polycarbonate polyol 55). Here, even when an excess amount of the first polycarbonate polyol is used, it is possible to add a polycarbonate polyol (second polycarbonate polyol) as a dispersion medium for the urethane reactive emulsifier. In this case, the polycarbonate polyol to be added may have the same chemical composition as the first polycarbonate polyol used in the step (i) or may have a different chemical composition.

On the other hand, in the step (i), when the first polycarbonate polyol and the first polyether are reacted in equivalent amounts, and the first polycarbonate polyol is completely consumed, in the step (ii), a new polycarbonate polyol is used as the second polycarbonate polyol to prepare a dispersion. In this case, the polycarbonate polyol used as the second polycarbonate polyol may have the same chemical composition as the first polycarbonate polyol or may have a different chemical composition.

Finally, in the step (iii), an elastic layer-forming mixture containing the dispersion prepared in the step (ii) and a polyisocyanate 56 having at least two isocyanate groups is prepared. Next, hydroxyl groups of the urethane reactive emulsifier 53, or hydroxyl groups of the second polycarbonate polyol 55, and isocyanate groups of the polyisocyanate 56 in the elastic layer-forming mixture are reacted with each other. In this manner, a network structure is formed via a urethane bond, and the elastic layer-forming mixture is cured to obtain a urethane elastomer. A urethane elastomer 500 obtained in this manner has a matrix-domain structure in which the domain 32 having a polyether structure of the first polyether 51 is dispersed in the matrix 31 having a polycarbonate structure of the first polycarbonate polyol 52 and the second polycarbonate polyol 55 which are unreacted materials. In addition, the domain 32 can be mainly composed of a polyether structure, and the inside of the domain can be substantially free of a cross-linked structure. In other words, the domain 32 can be present in a substantially liquid state in the matrix. Therefore, in the urethane elastomer, the domain can have a low elastic modulus.

In addition, it is considered that the domain is not simply trapped in the matrix, the domain and the matrix are chemically bonded via a urethane bond at the boundary part between the domain and the matrix. Therefore, when the load applied to the urethane elastomer is removed, the recovery of the domain from deformation can be linked to the recovery of the matrix from deformation. Therefore, the elastic layer according to the present disclosure is thought to have very fast recovery from deformation. In addition, when the recovery of the domain from deformation is linked to the recovery of the matrix from deformation, the elastic layer is able to recover better and more stably from deformation even when it is repeatedly subjected to loading and unloading.

Here, as described above, the domain can be in a substantially liquid state with substantially no internal cross-linked structure. This makes it possible to further increase the flexibility of the urethane elastomer. In this case, since the substantially liquid domain that has been deformed by application of a load to the urethane elastomer has a low elastic modulus, it is considered difficult for the domain to spontaneously recover from deformation. However, it is considered that, in the urethane elastomer according to the present disclosure, as described above, the domain and the matrix are chemically bonded at the boundary part with the matrix. Due to the presence of the chemical bond, the substantially liquid domain can also recover well from deformation together with the deformation recovery of the matrix. Therefore, the urethane elastomer having substantially liquid domains according to the present disclosure can achieve higher levels of flexibility and the recovery from deformation.

Here, the steps (i) to (ii) are steps of stably dispersing a polyether, which is inherently poorly compatible and difficult to disperse stably and uniformly, in a polycarbonate polyol. That is, the first polyether 51 is reacted with the first polycarbonate polyol 52 to form the urethane reactive emulsifier 53. This is a step of obtaining a dispersion in which a polyether segment corresponding to the first polyether 51 is stably and uniformly dispersed in a second polycarbonate polyol. Therefore, it is easy to prepare the urethane elastomer in which the domains 32 having a high circularity, small sizes on the micrometer order, and a relatively uniform size distribution are dispersed in the matrix 31.

Here, another method for mixing materials with low compatibility is, for example, a mixing and dispersing method using a high shear force. However, in this method, a high shear force is applied to the polyether, and as a result, the shapes of the domains are distorted, the circularity decreases, and the sizes of the domains also become non-uniform. In addition, the dispersion state is also unstable, and the domains aggregate in a relatively short time. In addition, the incompatibility between the polyether and the polycarbonate polyol is not secured, and the phase separation between the matrix and the domain of the obtained urethane elastomer becomes unclear. Therefore, according to the present disclosure, it is difficult to obtain a urethane elastomer that provides an elastic component that is flexible and has excellent deformation recovery.

The first polyether has at least one isocyanate group. In addition, the first polyether is preferably a polyether having a polyether structure represented by Formula (2). The first polyether can be obtained, for example, through a step of reacting a polyether polyol having at least two hydroxyl groups and having a polyether structure represented by Formula (2) with a polyisocyanate having at least two isocyanate groups.

Examples of polyether polyols include alkylene structure-containing polyether-based polyols such as polypropylene glycol, polytetramethylene glycol, copolymers of tetrahydrofuran and neopentyl glycol, copolymers of tetrahydrofuran and 3-methyltetrahydrofuran, and random or block copolymers of these polyalkylene glycols. These may be used alone or two or more thereof may be used in combination.

Among polyether polyols, an amorphous polyether polyol is preferable because the incompatibility with the second polycarbonate polyol and a low hardness can be achieved.

It is more preferable to contain at least one selected from the group consisting of polypropylene glycol, copolymers of tetrahydrofuran and neopentyl glycol, and copolymers of tetrahydrofuran and 3-methyltetrahydrofuran.

The number average molecular weight of the polyether polyol is preferably 1,000 to 50,000 and more preferably 1,200 to 30,000. When the number average molecular weight is 1,000 or more, this is preferable because the incompatibility with the polycarbonate polyol is secured and the phase separation between the matrix and the domain of the obtained urethane elastomer becomes clear. In addition, when the number average molecular weight is 50,000 or less, this is preferable because domains are easily formed and the phase separation form becomes stable.

The number average molecular weight of the polyether polyol can be calculated by the following Formula (3) using the hydroxy value (mg KOH/g) and the valence of the polyether polyol. For example, the number average molecular weight of a polyether polyol having a hydroxy value of 56.1 mg KOH/g and a valence of 2 can be calculated to be 2,000.

Number average molecular weight=56.1×1,000×valence÷hydroxy value (3)

Examples of polyisocyanates to be reacted with the polyether polyol include pentamethylene diisocyanate, hexamethylene diisocyanate, isophorone diisocyanate, 2,4-tolylene diisocyanate, 2,6-tolylene diisocyanate, xylylene diisocyanate, diphenylmethane diisocyanate, or trimeric compounds (isocyanurate) or polymeric compounds of these polyisocyanates, allophanate type polyisocyanates, burette type polyisocyanates, and water-dispersing type polyisocyanates. These polyisocyanates may be used alone or two or more thereof may be used in combination.

Among the polyisocyanates, a bifunctional isocyanate (diisocyanate) having two isocyanate groups is preferable because it has high compatibility with the first polyether and physical properties such as viscosity are easily adjusted. It is more preferable to contain at least one selected from the group consisting of hexamethylene diisocyanate, isophorone diisocyanate, 2,4-tolylene diisocyanate, 2,6-tolylene diisocyanate, xylylene diisocyanate, and diphenylmethane diisocyanate. Xylene diisocyanate is more preferable.

In the step of reacting a polyether polyol with a polyisocyanate, the isocyanate index is preferably 1.2 to 5.0. When the isocyanate index is within this range, the amount of the component derived from the first polyether remaining without being formed into a network structure can be reduced, and exudation of the liquid substance from the urethane elastomer can be curbed. Here, the isocyanate index indicates a value ratio ([NCO]/[OH]) of the number of moles of isocyanate groups in an isocyanate compound to the number of moles of hydroxyl groups in a polyol compound.

The first polyether obtained by reacting a polyether polyol with a polyisocyanate has a structure in which hydroxyl groups and isocyanate groups are reacted with each other to link them via urethane bonds. The number average molecular weight is preferably 1,000 to 50,000 and more preferably 1,200 to 30,000.

The number average molecular weight of the first polyether can be calculated using standard polystyrene molecular weight conversion or the hydroxy value (mg KOH/g) and the valence. The number average molecular weight in terms of polystyrene molecular weight can be measured using high performance liquid chromatography. Measurement can be performed using, for example, a high-speed GPC device (product name: HLC-8220GPC, commercially available from Tosoh Corporation) with two columns (Shodex GPCLF-804, molecular weight exclusion limit: 2×10⁶, separation range: 3×10² to 2×10⁶) in series. When the hydroxy value and the valence are used, the number average molecular weight can be calculated by the following formula. For example, the number average molecular weight of a polyol with 56.1 mg KOH/g and a valence of 2 can be calculated to be 2,000.

Number average molecular weight=56.1×1,000×valence÷hydroxy value

The number average molecular weight of the first polyether can be adjusted by changing the number average molecular weight of the polyether polyol or polyisocyanate used or by changing the reaction temperature, the reaction time or the like in the step of reacting a polyether polyol with a polyisocyanate.

The first polycarbonate polyol has at least two hydroxyl groups. In addition, the first polycarbonate polyol is preferably a polycarbonate polyol containing a polycarbonate structure represented by Formula (1). Examples of first polycarbonate polyols include reaction products of polyhydric alcohols and phosgene, and ring-opening polymers of cyclic carbonates (alkylene carbonates, etc.).

Examples of polyhydric alcohols include propylene glycol, dipropylene glycol, trimethylene glycol, 1,4-tetramethylenediol, 1,3-tetramethylenediol, 2-methyl-1,3-trimethylenediol, 1,5-pentamethylenediol, neopentyl glycol, 1,6-hexamethylenediol, 3-methyl-1,5-pentamethylenediol, 2,4-diethyl-1,5-pentamethylenediol, glycerin, trimethylolpropane, trimethylolethane, cyclohexanediols (1,4-cyclohexanediol, etc.), and sugar alcohols (xylitol, sorbitol, etc.).

Examples of alkylene carbonates include trimethylene carbonate, tetramethylene carbonate, and hexamethylene carbonate.

The number average molecular weight of the first polycarbonate polyol is preferably 500 to 10,000 and more preferably 700 to 8,000. If the number average molecular weight is 500 or more, when the domain has a polyether structure represented by Formula (2), the incompatibility with the domain is secured, and the phase separation between the matrix and the domain can be made clearer. In addition, when the number average molecular weight is 10,000 or less, it is possible to prevent the viscosity of the first polycarbonate polyol from excessively increasing.

The number average molecular weight of the first polycarbonate polyol can be calculated by the same method as the above method for calculating the number average molecular weight of the polyether polyol.

As the second polycarbonate polyol used in the step (ii), the polycarbonate polyols listed for the first polycarbonate polyol can be used. As described above, the first polycarbonate polyol and the second polycarbonate polyol may have the same chemical composition, or may be different from each other.

The amounts of the first polyether and the first polycarbonate polyol used are not particularly limited, and may be any amount at which droplets 54 can be dispersed in the second polycarbonate polyol 55 to form clear domains. For example, the ratio between the first polyether and the first polycarbonate polyol based on the mass is preferably 10:90 to 50:50, and more preferably 15:85 to 45:55.

As the polyisocyanate 56 having at least two isocyanate groups used in the step (iii), the same polyisocyanate as those reacted with polyether polyol exemplified as raw materials for the first polyether can be used. These polyisocyanates may be used alone or two or more thereof may be used in combination.

As the polyisocyanate 56, among the polyisocyanates exemplified above, in order to increase the elastic modulus of the matrix, it is preferable to include a polyisocyanate having at least three isocyanate groups such as a trimeric compound (isocyanurate) or polymeric compound of a polyisocyanate, an allophanate type polyisocyanate, and a burette type polyisocyanate.

It is more preferable to include at least one selected from the group consisting of a trimeric compound (isocyanurate) of pentamethylene diisocyanate, a trimeric compound (isocyanurate) of hexamethylene diisocyanate, a polymeric compound of diphenylmethane diisocyanate, and polymeric MDI.

Among the above examples, polymeric MDI is preferable. Here, polymeric MDI is a mixture of monomeric MDI and a high-molecular-weight polyisocyanate, and is represented by the following Formula (A). In Formula (A)′, n is preferably from 0 to 4.

As the polymeric MDI, commercially available products may be used, and examples thereof include Millionate MR series (commercially available from Tosoh Corporation) such as Millionate MR200 (product name).

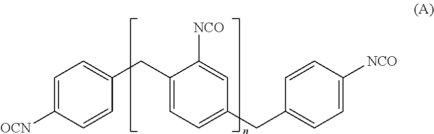

As the polyisocyanate 56 having at least two isocyanate groups, it is preferable to use a polyisocyanate having at least three isocyanate groups such as polymeric MDI in combination with a bifunctional isocyanate having two isocyanate groups. According to the above combination, the crosslink density of the matrix can be adjusted, and thus the combination is preferable because both a low hardness and a low compression set are achieved.

The amounts of the polyisocyanate having at least three isocyanate groups and the bifunctional isocyanate having two isocyanate groups are not particularly limited. The ratio of the amounts of bifunctional isocyanate:polyisocyanate having at least three isocyanate groups when mixed into the dispersion in the step (iii) is preferably 3:1 to 1:10, and more preferably 1:1 to 1:6. The amount of polyisocyanate per 100 parts by mass of the dispersion in the step (iii) is not particularly limited, and may be, for example, 1 to 10 parts by mass, or 3 to 8 parts by mass.

As the catalyst, known urethanization catalysts and isocyanuration catalysts (isocyanate trimerization catalysts) can be used. These may be used alone or in combination.

Examples of urethanization catalysts include tin-based urethanization catalysts such as dibutyltin dilaurate and stannous octoate, and amine-based urethanization catalysts such as triethylenediamine, tetramethylguanidine, pentamethyldiethylenetriamine, diethyl imidazole, tetramethylpropanediamine, N,N,N′-trimethylaminoethylethanolamine, and 1,4-diazabicyclo[2.2.2]octane-2-methanol. These may be used alone or in combination. Among these urethanization catalysts, triethylenediamine and 1,4-diazabicyclo[2.2.2]octane-2-methanol are preferable because they particularly accelerate the urethane reaction.

Examples of isocyanuration catalysts include metal oxides such as Li₂O and (Bu₃Sn)₂O, hydride compounds such as NaBH₄, alkoxide compounds such as NaOCH₃, KO-(t-Bu), and borate, amine compounds such as N(C₂H₅)₃, N(CH₃)₂CH₂C₂H₅, and 1,4-ethylenepiperazine (DABCO), alkaline carboxylate compounds such as HCOONa, Na₂CO₃, PhCOONa/DMF, CH₃COOK, (CH₃COO) 2Ca, alkaline soap, and naphthenate, alkaline formate compounds, and quaternary ammonium salt compounds such as ((R)₃—NR′OH)—OCOR″. Here, Bu represents a butyl group, Ph represents a phenyl group, R, R′ and R″ represent any alkyl group.

In addition, examples of combined catalysts (cocatalysts) used as isocyanuration catalysts include amine/epoxide, amine/carboxylic acid, and amine/alkyleneimide. These isocyanuration catalysts and combined catalysts may be used alone or in combination.

As a catalyst for urethane synthesis, N,N,N′-trimethylaminoethylethanolamine (hereinafter referred to as ETA), which acts alone as a urethanization catalyst and also acts as an isocyanuration catalyst may be used.

In the method for producing a urethane elastomer, as necessary, a chain extension agent (multifunctional low-molecular-weight polyol) may be used. Examples of chain extension agents include a glycol having a number average molecular weight of 1,000 or less. Examples of glycols include ethylene glycol (EG), diethylene glycol (DEG), propylene glycol (PG), dipropylene glycol (DPG), 1,4-butanediol (1,4-BD), 1,6-hexanediol (1,6-HD), 1,4-cyclohexanediol, 1,4-cyclohexane dimethanol, xylylene glycol (terephthalyl alcohol), and triethylene glycol.

In addition, examples of chain extension agents other than glycols include trihydric or higher polyhydric alcohols. Examples of trihydric or higher polyhydric alcohols include trimethylolpropane, glycerin, pentaerythritol, and sorbitol. These may be used alone or in combination.

In addition, as necessary, additives such as a pigment, a plasticizer, a water-proofing agent, an antioxidant, a conducting agent, a UV absorbing agent, and a light stabilizer may be used in combination.

### (Method for Producing Elastic Layer)

The elastic layer can be formed, for example, by performing the reacting step in the step (iii) in the above method for producing a urethane elastomer on the circumferential surface of the shaft core. Here, the other conditions to be used can be the same as those in the method for producing a urethane elastomer.

Specifically, for example, a method for preparing a mixture containing the dispersion prepared in the step (ii) and a polyisocyanate having at least two isocyanate groups and curing it on the circumferential surface of a shaft core may be exemplified. That is, the method for producing an elastic layer is, for example, a method including the following steps (2-i) to (2-iv).
Step (2-i): a step of obtaining a urethane reactive emulsifier having at least two hydroxyl groups by reacting a first polyether having at least one isocyanate group with a first polycarbonate polyol having at least two hydroxyl groups.
Step (2-ii): a step of mixing the urethane reactive emulsifier and a second polycarbonate polyol to obtain a dispersion in which droplets containing at least a part of the urethane reactive emulsifier is dispersed in the second polycarbonate polyol.
Step (2-iii): a step of mixing the dispersion obtained in the step (2-ii) and a polyisocyanate having at least two isocyanate groups to obtain an elastic layer-forming mixture.
Step (2-iv): a step of reacting the urethane reactive emulsifier, the second polycarbonate polyol, and the polyisocyanate having at least two isocyanate groups in the elastic layer-forming mixture on the circumferential surface of a shaft core.

As a method for curing the elastic layer-forming mixture on the circumferential surface of the shaft core, for example, a method (cast molding method) in which the material for the elastic layer, including the elastic layer-forming mixture, is injected into a mold in which a cylindrical pipe, a piece for holding the shaft core, and the shaft core are disposed, and thermally cured can be used. In addition, a method in which the material for the elastic layer, including the elastic layer-forming mixture, is applied onto the circumferential surface of the shaft core to form a coating film, and the coating film is heated and cured can also be used.

In addition, it is preferable to additionally perform aging after the elastic layer-forming mixture is cured on the circumferential surface of the shaft core.

### (Surface Layer)

As necessary, a surface layer can be provided on the surface of the elastic layer. Examples of materials for forming the surface layer include a resin, natural rubber, and synthetic rubber. As the resin, a thermosetting resin or a thermoplastic resin can be used. Particularly, the resin is preferably a fluorine resin, a polyamide resin, an acrylic resin, a polyurethane resin, a silicone resin, or a butyral resin because it is easy to control the viscosity of a coating material. These resins may be used alone or two or more thereof may be used in combination. In addition, copolymers may be used.

In order to adjust the electrical resistance of the electrophotographic roller, a conducting agent can be added to the surface layer. The volume resistivity of the surface layer can be adjusted by an ion conducting agent or an electron conducting agent.

Examples of ion conducting agents include the following: inorganic ionic substances such as lithium perchlorate, sodium perchlorate, and calcium chlorate, cationic surfactants such as lauryltrimethylammonium chloride, stearyl trimethyl ammonium chloride, octadecyltrimethylammonium chloride, dodecyltrimethylammonium chloride, hexadecyltrimethylammonium chloride, trioctylpropylammonium bromide, and modified aliphatic dimethylethylammonium ethosulfate, zwitterionic surfactants such as lauryl betaine, stearyl betaine, and dimethyl alkyl lauryl betaine, quaternary ammonium salts such as tetraethylammonium perchlorate, tetrabutylammonium perchlorate, and trimethyloctadecylammonium perchlorate, and lithium salts of organic acids such as lithium trifluoromethanesulfonate. These may be used alone or two or more thereof may be used in combination.

Examples of electron conducting agents include the following: metal-based fine particles and fibers such as aluminum, palladium, iron, copper, and silver, conductive metal oxides such as titanium oxide, tin oxide, and zinc oxide, composite particles in which the surfaces of the metal-based fine particles, fibers or metal oxides are subjected to a surface treatment by an electrolysis treatment, spray coating, or mixing and shaking, and carbon powders such as furnace black, thermal black, acetylene black, ketjen black, polyacrylonitrile (PAN)-based carbon, and pitch-based carbon.

The surface layer may also contain other particles. Examples of other particles include insulating particles. Examples of insulating particles include the following: polyamide resins, silicone resins, fluorine resins, (meth)acrylic resins, styrene resins, phenol resins, polyester resins, melamine resins, urethane resins, olefin resins, epoxy resins, and copolymers, modified products and derivatives thereof, rubber such as ethylene-propylene-diene copolymers (EPDM), styrene-butadiene copolymer rubber (SBR), silicone rubber, urethane rubber, isoprene rubber (IR), butyl rubber, acrylonitrile-butadiene copolymer rubber (NBR), chloroprene rubber (CR), and epichlorohydrin rubber, and polyolefin thermoplastic elastomers, urethane-based thermoplastic elastomers, polystyrene-based thermoplastic elastomers, fluorine rubber-based thermoplastic elastomers, polyester-based thermoplastic elastomers, polyamide-based thermoplastic elastomers, polybutadiene-based thermoplastic elastomers, ethylene vinyl acetate-based thermoplastic elastomers, polyvinyl chloride-based thermoplastic elastomers, and chlorinated polyethylene-based thermoplastic elastomers. Among these, (meth)acrylic resins, styrene resins, urethane resins, fluorine resins, and silicone resins are particularly preferable.

The material constituting such a surface layer can be dispersed using a known dispersion device that utilizes beads such as a sand mill, a paint shaker, a dyno mill, or a pearl mill. The method for applying the obtained dispersion solution is not particularly limited, and a dipping method is preferable because it is easy to operate.

### <Electrophotographic Image Forming Apparatus>

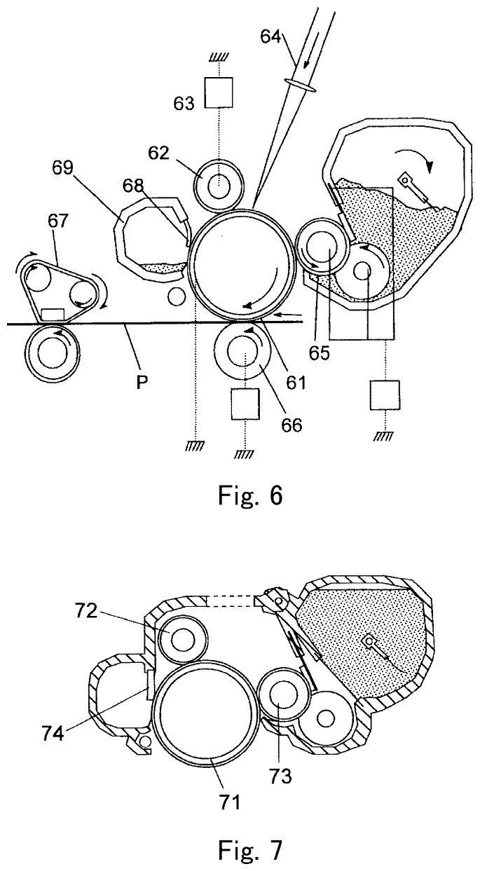

FIG. 6 shows a schematic configuration of an example of an electrophotographic image forming apparatus including an electrophotographic member according to one embodiment of the present disclosure.

In FIG. 6, the image forming apparatus includes a photosensitive member 61, a charging apparatus, a latent image forming apparatus, a developing apparatus, a transfer apparatus, a cleaning apparatus, and a fixing apparatus.

The photosensitive member 61 is a rotating drum having a photosensitive layer on a conductive substrate. The photosensitive member 61 is driven to rotate in the arrow direction at a predetermined circumferential speed (process speed).

The charging apparatus has a function of charging the photosensitive member 61, and includes a contact type charging roller 62 that is brought into contact and placed in contact with the photosensitive member 61 by applying a predetermined pressing force. The charging roller 62 rotates in the arrow direction as the photosensitive member 61 rotates. The charging roller 62 charges the photosensitive member 61 to a predetermined potential by applying a predetermined DC voltage from a charging power source 63.

The latent image forming apparatus (not shown) performs exposure to form an electrostatic latent image on the photosensitive member 61. As the latent image forming apparatus, an exposure apparatus such as a laser beam scanner is used. The latent image forming apparatus forms an electrostatic latent image by emitting exposure light 64 corresponding to image information to the uniformly charged photosensitive member 61.

The developing apparatus has a function of developing a toner image, and includes a developing roller 65 that is disposed adjacent to or in contact with the photosensitive member 61. The developing roller 65 develops the electrostatic latent image by reversal development using a toner that has been electrostatically treated to have the same polarity as the charge polarity of the photosensitive member 61, and forms a toner image on the photosensitive member 61.

The transfer apparatus has a function of transferring the developed toner image onto a recording material P, and includes a contact type transfer roller 66. The transfer roller 66 rotates in the arrow direction as the photosensitive member 61 rotates, and transfers the toner image from the photosensitive member 61 onto the recording material P such as plain paper. Here, the recording material P is transported in the arrow direction by a paper feed system (not shown) having a transport member.

The cleaning apparatus has a function of collecting the transfer residual toner on the photosensitive member 61, and includes a blade type cleaning member 68 and a collection container 69. The cleaning apparatus mechanically scrapes off and collects the transfer residual toner remaining on the photosensitive member 61 after the toner image is transferred onto the recording material P.

Here, when a simultaneous development and cleaning system in which the developing apparatus collects the transfer residual toner is used, it is possible to omit the cleaning apparatus.

The fixing apparatus has a function of fixing a toner image, and is composed of a fixing belt 67 having a heated roller, and fixes the toner image transferred onto the recording material P according to rotation in the arrow direction, and discharges the recording material P outside the apparatus.

In the image forming apparatus, the above electrophotographic member can be suitably used as the charging roller 62 or the developing roller 65. That is, the electrophotographic image forming apparatus can include the electrophotographic member of the present disclosure.

### <Process Cartridge>

FIG. 7 shows a schematic configuration of one embodiment of a process cartridge according to one embodiment of the present disclosure. The process cartridge integrates a photosensitive member 71, a charging roller 72, a developing roller 73, and a cleaning member 74, and is detachable from the main body of the electrophotographic image forming apparatus. The process cartridge includes the above electrophotographic member according to one embodiment of the present disclosure, and such an electrophotographic member can be particularly suitably used as the charging roller 72 or the developing roller 73.

That is, the process cartridge is a process cartridge detachable from the main body of the electrophotographic image forming apparatus, and may be a process cartridge including the electrophotographic member of the present disclosure.

### EXAMPLES

One embodiment of the present disclosure will be described below in more detail with reference to examples. However, the present disclosure is not limited to the following examples.

### Example 1

### (Preparation of Elastic Layer-Forming Mixture)

20.1 parts by mass of polypropylene glycol (product name: PREMINOL S 4013F, commercially available from AGC Inc.), 19.2 parts by mass of polypropylene glycol (product name: UNIOL D-4000, commercially available from NOF Corporation), 2.5 parts by mass of xylylene diisocyanate (XDI) (commercially available from Tokyo Chemical Industry Co., Ltd.), and 500 ppm of 1,4-diazabicyclo[2.2.2]octane-2-methanol (product name: RZETA, commercially available from Tosoh Corporation) as a curing catalyst were put into a closed mixer, and the mixture was stirred for 4 hours in the closed mixer adjusted to 100° C. to synthesize a first polyether having two isocyanate groups.

Here, in the following examples and comparative examples, the amount of the curing catalyst is expressed in ppm by mass based on the mass of the elastic layer-forming mixture excluding the curing catalyst.

50.4 parts by mass of polycarbonate diol (product name: Duranol G3452, commercially available from Asahi Kasei Corporation) was mixed therewith. Then, the mixture was additionally stirred for 2 hours in a closed mixer adjusted to 100° C. to synthesize a urethane reactive emulsifier having two hydroxyl groups (step (2-i)), and a dispersion in which droplets containing at least a part of the urethane reactive emulsifier were dispersed in the polycarbonate diol was obtained (step (2-ii)).

2.0 parts by mass of carbon black (product name: Denka Black powder, commercially available from Denka Co., Ltd.) was added to the dispersion, and the mixture was stirred using a rotation and revolution vacuum defoaming mixer for 3 minutes under conditions of a rotational speed of 800 rpm and a revolution speed of 1,600 rpm to obtain a dispersion in which carbon black was dispersed.

Next, 1.0 part by mass of xylylene diisocyanate (commercially available from Tokyo Chemical Industry Co., Ltd., hereinafter sometimes referred to as “XDI”) and 5.0 parts by mass of polyisocyanate (product name: Millionate MR-200, commercially available from Tosoh Corporation, hereinafter sometimes referred to as “MR-200”) were added to the dispersion in which carbon black was dispersed, and the mixture was stirred using a rotation and revolution vacuum defoaming mixer for 2 minutes under conditions of a rotational speed of 800 rpm and a revolution speed of 1,600 rpm to obtain an elastic layer-forming mixture.

(Step (2-iii)).

### (Preparation of Electrophotographic Roller)

A primer (product name: Metaloc N-33, commercially available from Toyokagaku Kenkyusho Co., Ltd.) was applied to a SUS304 shaft core with a diameter of 6 mm and a length of 250 mm and baked at 130° C. for 30 minutes. Next, this shaft core was placed concentrically in a cylindrical mold with an inner diameter of 11.5 mm, and the elastic layer-forming mixture was injected into the cylindrical mold preheated to 130° C. over 10 seconds.

The cylindrical mold was heated at 130° C. for 1 hour, the mold was then removed, and aging was additionally performed at 80° C. for 2 days to obtain an elastic layer (step 2-iv). The ends of the elastic layer were additionally removed to obtain an electrophotographic roller with a length of 225 mm and an elastic layer thickness of 2.0 mm. The obtained electrophotographic roller was subjected to the following evaluations.

### <Method for Evaluating Electrophotographic Roller>

### (Evaluation 1: Confirmation and Analysis of Matrix and Domain)

Using a cryo-microtome system (product name: EM FC6, commercially available from Leica Microsystems) and an ultramicrotome (product name: EM UC6, commercially available from Leica Microsystems), ultrathin sections (500 μm×500 μm×5 μm) were prepared from the elastic layer of the electrophotographic roller. The locations for preparing sections were a total of three locations including the center of the elastic layer in the longitudinal direction and two locations of L/4 from both ends of the elastic layer toward the center when the length of the elastic layer in a longitudinal direction is L, and sections of the elastic layer having an exposed cross section in which the domain and the matrix were exposed in the thickness direction were prepared.

Mapping measurement was performed on the prepared sections using an infrared microscope imaging system (product name: Spectrum400 (spectrometer) and Spotlight 400 (scanning device, commercially available from PerkinElmer Co., Ltd.) to create mapping images. For the measurement, mapping measurement was performed using ATR imaging accessories under conditions: pixel size: 1.56 μm, resolution: 16 cm-1, field of view: 300 μm×300 μm, and scanning speed: 1.0 cm/s. The mapping image is an image of the magnitude of the integrated value of the infrared absorption spectrum for each pixel. The presence of the matrix and the domain was confirmed from the obtained mapping image. In addition, it was confirmed that the matrix had a structure corresponding to polycarbonate diol from the infrared absorption spectrum of the matrix of the mapping image. In addition, it was confirmed that the domain had a structure corresponding to polypropylene glycol from the infrared absorption spectrum of the domain of the mapping image. That is, it was confirmed that the matrix had a carbonate structure represented by Formula (1), and the domain had an ether structure represented by Formula (2).

### (Evaluation 2: Measurement of Micro Rubber Hardness)

The micro rubber hardness of the elastic layer was measured using a micro rubber hardness meter (product name: MD-1capa, commercially available from Kobunshi Keiki Co., Ltd.). For the measurement, the electrophotographic roller was left in an environment at a temperature of 23° C. for 24 hours or longer, and the measurement was performed using a measurement device left in the same environment. In addition, the push pin used was a type A (push pin shape: a height of 0.50 mm, a diameter of 0.16 mm, cylindrical, a pressure leg size: an outer diameter of 4 mm, an inner diameter of 1.5 mm), and the measurement mode was a peak hold mode.

The locations for measuring the micro rubber hardness were a total of three locations including the center of the elastic layer in the longitudinal direction and two locations of L/4 from both ends of the elastic layer toward the center when the length of the elastic layer in a longitudinal direction is L. The micro rubber hardness was measured once at each measurement location at a temperature of 23° C.

### (Evaluation 3: Measurement of Parameter Indicating Viscoelasticity Term)

In the same manner as in Evaluation 1, from a total of three locations including the center of the elastic layer in the longitudinal direction and two locations of L/4 from both ends of the elastic layer toward the center, ultrathin sections having a cross section in which the domain and the matrix were exposed were prepared.

An arbitrary square observation region with a side of 50 μm was selected in the thickness region from the outer surface of each section to a position of a depth of 100 μm, and in a total of three observation regions, the viscoelasticity image was measured using a scanning probe microscope (product name: S-Image, commercially available from SII NanoTechnology Inc.). The viscoelasticity image measurement mode was VE-DFM. In addition, as the cantilever, “SI-DF3” (product name, commercially available from Hitachi High-Tech Science Corporation, spring constant=1.9 N/m) was used. In addition, the scanning frequency was 0.5 Hz.

From the obtained viscoelasticity image, in each observation region, the parameters indicating the viscoelasticity term were calculated for 10 points each for the matrix and the domain, and the parameter A (mV) indicating the viscoelasticity term of the domain and the parameter B (mV) indicating the viscoelasticity term of the matrix were calculated from their arithmetic average values.

Here, it was confirmed from the viscoelasticity image taken by SPM that the domain was exposed and the matrix was exposed in the cross section.

(Evaluation 4: Measurement of Recovery of Elastic Layer from Deformation)

The recovery of the elastic layer from deformation was evaluated by an indentation test using a nanoindenter (product name: HM2000, commercially available from Fischer Instruments K.K.) at a temperature of 23° C. For the measurement, the electrophotographic roller was left in an environment at a temperature of 23° C. for 24 hours or longer, and the measurement was performed using a measurement device left in the same environment.

The measurement locations were a total of three locations including the center of the elastic layer in the longitudinal direction and two locations of L/4 from both ends of the elastic layer toward the center when the length of the elastic layer in a longitudinal direction is L. In the indentation test, a Vickers indenter was brought into contact with the matrix on the outer surface of the elastic layer, the Vickers indenter (square pyramid shape, facing angle) 136° was pressed into the elastic layer at a load rate of 10 mN/30 seconds, and a load of 10 mN was maintained for 60 seconds. Then, unloading was performed at an unload rate of 10 mN/sec, and the strain 5 seconds after unloading was completed was measured once at each measurement location.

### (Evaluation 5: Measurement of Elastic Modulus of Matrix)

In the same manner as in Evaluation 1, from a total of three locations including the center of the elastic layer in the longitudinal direction and two locations of L/4 from both ends of the elastic layer toward the center, ultrathin sections having an exposed cross section in which the domain and the matrix were exposed were prepared.

A square observation region with a side of 50 μm was set at an arbitrary position in a region corresponding to a thickness region from the outer surface of the elastic layer of each section to a depth of 100 μm. Thus, in a total of three observation regions, the phase image was observed using a scanning probe microscope (product name: MFP-3D-Origin, commercially available from Oxford Instruments). The phase image measurement mode was AM-AFM. In addition, as the cantilever, “OMCL-AC-160TS” (product name, commercially available from Olympus Corporation, spring constant=47.08 N/m) was used. In addition, the scanning frequency was 0.5 Hz.

From the obtained phase image, the elastic modulus of the matrix was obtained by measuring a force curve using the scanning probe microscope. The force curve measurement mode was a contact mode, Force Distance was 500 nm, and Trigger Point was 0.01 V. In addition, as the cantilever, “OMCL-AC-160TS” (product name, commercially available from Olympus Corporation, spring constant=47.08 N/m) was used. In addition, the scanning frequency was 1 Hz.

For each observation region, the elastic modulus of the matrix was calculated at 10 points, and the arithmetic average value thereof was calculated.

Here, it was confirmed from the phase image taken by SPM that the domain was exposed and the matrix was exposed in the cross section.

### (Evaluation 6: Evaluation of Proportion of Area of Conductive Fillers Present in Each of Matrix and Domain)

Using a cryo-microtome system (product name: EM FC6, commercially available from Leica Microsystems) and an ultramicrotome (product name: EM UC6, commercially available from Leica Microsystems), sections (500 μm×500 μm×100 nm) were prepared from the electrophotographic roller. The locations for preparing sections were a total of three locations including the center of the elastic layer in the longitudinal direction and two locations of L/4 from both ends of the elastic layer toward the center when the length of the elastic layer in a longitudinal direction is L, and sections of the elastic layer having an exposed cross section in which the domain and the matrix were exposed in the thickness direction were prepared.

A square observation region with a side of 50 μm was set at an arbitrary position in a region corresponding to a thickness region from the outer surface of the elastic layer of each section to a depth of 100 μm. Thus, in a total of three observation regions, using a high-resolution electron-energy-loss spectroscope (product name: H-7100FA, commercially available from Hitachi High-Tech Corporation) in which a transmission electron microscope (TEM) and an electron energy loss spectroscopy (EELS) were combined, under conditions of an acceleration voltage of 100 kV, an observation magnification of 3,000, and a beam diameter of 2 nm, a TEM image of the observation region and an oxygen atom mapping image (hereinafter simply referred to as a “mapping image”) were obtained.

It was confirmed from the TEM image that the matrix and the domain were present in the observation region. In addition, in the mapping image, a region containing no oxygen atom, that is, a carbon black (conductive filler) part, could be distinguished from the urethane elastomer region. Thus, from the TEM image and the mapping image, carbon black present in the matrix and carbon black present in the domain were identified.

Next, the mapping image was binarized to a carbon black part and a urethane elastomer part using image processing software (product name: ImageProPlus, commercially available from Media Cybernetics, Inc.) to obtain a binarized image for analysis. The threshold value for binarization was determined from the mapping image brightness distribution based on the Otsu's algorithm described in IEEE Transactions on SYSTEMS, MAN, AND CYBERNETICS, Vol. SMC-9, No. 1, January 1979, pp. 62-66.

Next, from the obtained binarized image, using the count function of the image processing software, the total area of carbon black (conductive filler) present in the matrix in the observation region and the total area of carbon black (conductive filler) present in the domain in the observation region were calculated. Thus, the ratio (area proportion) of the total area of carbon black present in the matrix to the total area of carbon black present in the observation region was calculated.

### (Evaluation 7: Measurement of Cross-Sectional Area and Number of Domains)

Each of the three viscoelasticity images obtained in Evaluation 3 was converted into a 256-gradation grayscale image using image processing software (product name: ImageProPlus, commercially available from Media Cybernetics, Inc.), and then binarized to obtain a binarized image for analysis. The threshold value for binarization was determined from the monochrome image brightness distribution based on the Otsu's algorithm described in IEEE Transactions on SYSTEMS, MAN, AND CYBERNETICS, Vol. SMC-9, No. 1, January 1979, pp. 62-66.

In addition, from the obtained binarized image, the cross-sectional area of the domain, the number of domains, and the average cross-sectional area of the domains were calculated using the count function of the image processing software. However, among the domains determined by the count function, domains with a cross-sectional area of less than 0.05 area % in the observation region of 50 μm squares were considered as noise and removed from data. Thus, the proportion (area %) of the total cross-sectional area of the domain in each observation region relative to the area of the observation region was calculated.

In addition, among the domains in each observation region, the number of domains having a cross-sectional area that was 0.1 to 13.0 area % of the area of the observation region was determined, and the proportion (area %) of the number of domains having a cross-sectional area of 0.1 to 13.0 area % relative to the area of the observation region was determined.

### (Evaluation 8: Measurement of Circularity and Number of Domains)

From the binarized image obtained in Evaluation 7, the circularity and average circularity of the domain were calculated using the count function of the image processing software. However, in the same manner as in Evaluation 7, noise was removed from data. Thus, among the domains in each observation region, the number of domains with a circularity of 0.60 to 0.95 was counted, and the proportion (%) of the number of domains with a circularity of 0.60 to 0.95 based on the total number of domains in each observation region was calculated.

### (Evaluation 9: Evaluation of Streaky Image Defects)

A color laser printer (product name: LBP7700C, commercially available from Canon Inc.) and a process cartridge incorporating an electrophotographic roller as a developing roller were allowed to acclimate to an environment at a temperature of 23° C. and a humidity of 50% RH for 24 hours, and the image was then evaluated.

Specifically, the process cartridge incorporating an electrophotographic roller as a developing roller was installed in the color laser printer. Thus, ten sheets of halftone images (images in which horizontal lines with a width of 1 dot and an interval of 2 dots were drawn in a direction perpendicular to the rotation direction of the photosensitive member) were consecutively output, and the obtained images were visually observed to determine streaky image defects according to the following two criteria.

### <Evaluation of Streaky Image Defects 9-1>

Rank A: No streaky image defects were observed from the first sheet onwards.
Rank B: Streaky image defects were observed only on the first sheet.
Rank C: Streaky image defects were observed from the second sheet onwards.

### <Evaluation of Streaky Image Defects 9-2>

Rank A: No streaky image defects were observed in the entire electrophotographic roller in the longitudinal direction.
Rank B: Streaky image defects were observed in some regions of the electrophotographic roller in the longitudinal direction.
Rank C: Streaky image defects were observed in a wide range of the electrophotographic roller in the longitudinal direction, and noticeable.

### (Evaluation 10: Evaluation of Scraping of Ends, Toner Melt Adhesion, and Image Defects Due to Toner Melt Adhesion)

The color laser printer and the process cartridge incorporating an electrophotographic roller as a developing roller were allowed to acclimate to an environment at a temperature of 23° C. and a humidity of 50% RH for 24 hours.

Then, the electrophotographic roller as a developing roller was installed in the color laser printer, and 10,000 sheets of images in which horizontal lines with a width of 2 dots and an interval of 50 dots were drawn were consecutively output. While 10,000 sheets were consecutively output, the developing roller was taken out every 1,000 sheets, the developing roller was visually observed, and scraping of the ends of the developing roller and toner melt adhesion were determined according to the following criteria.

### <Evaluation 10-1: Evaluation of Scraping of Ends>

The number of sheets output when scraping of the ends of the developing roller was observed was taken as the number of sheets in which scraping occurred.

### <Evaluation 10-2: Evaluation of Toner Melt Adhesion>

The number of sheets output when toner melt adhesion was observed in the developing roller was taken as the number of sheets in which melt adhesion occurred.

### <Evaluation 10-3: Evaluation of Image Defects Due to Toner Melt Adhesion>

While 10,000 sheets were consecutively output, the output images were checked every 10 sheets. If there was an image defect such as toner being transferred to a paper sheet at intervals of one revolution of the electrophotographic roller in parts other than the horizontal lines, the output was temporarily stopped, and the electrophotographic roller was taken out from the process cartridge. When the position where image defects occurred was aligned with the location and size of the toner melt adhesion part of the electrophotographic roller, the number of sheets output when the output was temporarily stopped was taken as the number of sheets in which image defects occurred due to toner melt adhesion.

### (Evaluation 11: Evaluation of Solid Image Density)

A color laser printer (product name: LBP7700C, commercially available from Canon Inc.) and a process cartridge incorporating an electrophotographic roller as a developing roller were allowed to acclimate to an environment at a temperature of 15° C. and a humidity of 10% RH for 24 hours, a full solid image was then printed on one sheet in the same environment, and the density was evaluated.

For density evaluation, a spectrodensitometer: X-Rite504 (product name, commercially available from S.D.G K.K.) was used for measurement. Here, the image density was an average value of the image densities measured at 15 randomly selected points on one full solid image. The image density that satisfied the following criteria was “OK” and the image density that did not satisfy the following criteria was “NG”. When the full solid image did not satisfy the following criteria, the image density was determined to be sufficient.

Criterion: The average value of the image densities measured at 15 random points on one full solid image was 1.3 or more.

### Examples 2 to 7, 9 to 12, 14, 15, and 18

Elastic layers were formed in the same manner as in Example 1 except that the materials shown in Table 4 were used in the addition amounts shown in Table 4 to prepare elastic layer-forming mixtures, and thereby electrophotographic rollers according to examples were prepared. The obtained electrophotographic rollers were evaluated in the same manner as in Example 1.

Here, the details of materials in Table 4 are shown in Table 1, Table 2 and Table 3. The same applies to the following examples.

### Example 8

An elastic layer was formed in the same manner as in Example 1 except that the materials shown in Table 4 were used in the addition amounts shown in Table 4 to prepare an elastic layer-forming mixture and the elastic layer-forming mixture was injected into the cylindrical mold for 5 seconds, and thereby an electrophotographic roller according to Example 8 was prepared. The obtained electrophotographic roller was evaluated in the same manner as in Example 1.

### Examples 13, 16, and 17

Elastic layers were formed in the same manner as in Example 1 except that the materials shown in Table 4 were used in the addition amounts shown in Table 4 to prepare elastic layer-forming mixtures and the elastic layer-forming mixture was injected into the cylindrical tube for 3 seconds, and thereby electrophotographic rollers according to examples were prepared. The obtained electrophotographic rollers were evaluated in the same manner as in Example 1.

TABLE 1

| | | Number of carbon | |
|---|---|---|---|
| | | atoms for R² in | |
| Number | Material A | General Formula (2) | Mn |
| A1 | Polypropylene glycol | 3 (branched) | 12,000 |
| | “PREMINOL S4013F” | | |
| | (product name, commercially available from AGC Inc.) | | |
| A2 | Polypropylene glycol | 3 (branched) | 4,000 |
| | “UNIOL D-4000” | | |
| | (product name, commercially available from NOF | | |
| | Corporation) | | |
| A3 | Polypropylene glycol | 3 (branched) | 2,000 |
| | “UNIOL D-2000” | | |
| | (product name, commercially available from NOF | | |
| | Corporation) | | |
| A4 | Polytetramethylene glycol | 4 (linear) | 2,000 |
| | “PTMG2000” | | |
| | (product name, commercially available from Mitsubishi | | |
| | Chemical Corporation) | | |
| A5 | Tetrahydrofuran-neopentyl glycol copolymer | 4 (linear) + | 1,800 |
| | “PTXG-1800” | 5 (branched) | |
| | (product name, commercially available from Asahi | | |
| | Kasei Corporation) | | |

In the table, the tetrahydrofuran-neopentyl glycol copolymer is a polyether glycol represented by HO—(CH₂CH₂CH₂CH₂O)m-(CH₂C(CH₃)₂CH₂O)n-OH. That is, regarding the number of carbon atoms of a tetrahydrofuran-neopentyl glycol copolymer, the description of 4 (linear)+5 (branched) indicates that R² includes a linear structure having 4 carbon atoms and a branched structure having 5 carbon atoms.

TABLE 2

| | | Number of carbon | |
|---|---|---|---|
| | | atoms for R¹ in | |
| Number | Material B | General Formula (1) | Mn |
| B1 | Polycarbonate diol | 3 (linear) + | 2,000 |
| | “Duranol G3452” | 4 (branched) | |
| | (product name, commercially available from | | |
| | Asahi Kasei Corporation) | | |
| B2 | Polycarbonate polyol | 6 (linear) + | 2,000 |
| | “Kuraray polyol C-2090” | 6 (branched) | |
| | (product name, commercially available from | | |
| | Kuraray Co., Ltd.) | | |
| B3 | Polycarbonate polyol | 9 (linear) + | 2,000 |
| | “Kuraray polyol C-2065N” | 9 (branched) | |
| | (product name, commercially available from | | |
| | Kuraray Co., Ltd.) | | |
| B4 | Polycarbonate diol | 6 (linear) | 2,000 |
| | “Duranol T6002” | | |
| | (product name, commercially available from | | |
| | Asahi Kasei Corporation) | | |
| B5 | Polyester polyol | — | 2,000 |
| | “Kuraray polyol P-2050” | | |
| | (product name, commercially available from | | |
| | Kuraray Co., Ltd.) | | |

In the table, Kuraray polyol C-2090 (commercially available from Kuraray Co., Ltd.) is a polycarbonate polyol having a number average molecular weight of 2,000, a hydroxy value of 56.3 mg KOH/g, and a structure corresponding to 1,6-hexanediol and a structure corresponding to 3-methyl-1,5-pentanediol. That is, regarding the number of carbon atoms of polycarbonate diol and polycarbonate polyol, for example, the description of 6 (linear)+6 (branched) indicates that R¹ includes a linear structure having 6 carbon atoms and a branched structure having 6 carbon atoms. In addition, Kuraray polyol P-2050 is a polyester polyol having a structure corresponding to adipic acid and a structure corresponding to 3-methyl-1,5-pentanediol.

TABLE 3

| Number | Material C |
|---|---|
| C1 | Carbon black |
| | “Denka Black powder” |
| | (product name, commercially |
| | available from Denka Co., Ltd.) |
| C2 | Carbon black |
| | “NIPex160IQ” |
| | (product name, commercially available |
| | from Orion Engineered Carbons) |

TABLE 4

| | | | | | | | | | | XDI | |
|---|---|---|---|---|---|---|---|---|---|---|---|
| | | Material A | | Material A | | Material B | | Material C | | Parts | MR-200 |
| | | | Parts by | | Parts by | | Parts by | | Parts by | by | Parts by |
| | | Type | mass | Type | mass | Type | mass | Type | mass | mass | mass |
| Example | 1 | A1 | 20.1 | A2 | 19.2 | B1 | 50.4 | C1 | 2.0 | 3.5 | 5.0 |
| | 2 | A2 | 6.2 | A3 | 5.3 | B3 | 75.4 | C1 | 2.0 | 4.7 | 6.7 |
| | 3 | A2 | 19.8 | A3 | 18.9 | B3 | 49.5 | C1 | 2.0 | 5.6 | 4.3 |
| | 4 | A2 | 25.1 | — | — | B2 | 62.8 | C2 | 3.0 | 4.3 | 6.1 |
| | 5 | A5 | 24.7 | — | — | B2 | 61.8 | C1 | 2.0 | 5.4 | 6.3 |
| | 6 | A1 | 20.1 | A2 | 19.2 | B2 | 50.2 | C1 | 2.0 | 3.6 | 5.2 |
| | 7 | A2 | 6.2 | A3 | 5.3 | B2 | 75.3 | C1 | 2.0 | 4.8 | 6.6 |
| | 8 | A2 | 25.1 | — | — | B2 | 62.8 | C2 | 3.0 | 4.3 | 6.1 |
| | 9 | A2 | 25.1 | — | — | B5 | 62.7 | C1 | 2.0 | 4.4 | 6.1 |
| | 10 | A4 | 24.7 | — | — | B2 | 61.8 | C1 | 2.0 | 5.2 | 6.5 |
| | 11 | A2 | 25.1 | — | — | B4 | 62.7 | C1 | 2.0 | 4.2 | 6.1 |
| | 12 | A1 | 44.4 | — | — | B2 | 46.2 | C1 | 2.0 | 3.2 | 4.5 |
| | 13 | A2 | 25.1 | — | — | B2 | 62.8 | C2 | 3.0 | 4.3 | 6.1 |
| | 14 | A1 | 44.3 | — | — | B5 | 46.1 | C2 | 3.0 | 3.2 | 4.6 |
| | 15 | A3 | 7.0 | — | — | B4 | 79.2 | C2 | 3.0 | 5.0 | 7.0 |
| | 16 | A1 | 44.3 | — | — | B5 | 46.1 | C2 | 3.0 | 3.2 | 4.6 |
| | 17 | A3 | 7.0 | — | — | B4 | 79.2 | C2 | 3.0 | 5.0 | 7.0 |
| | 18 | A3 | 7.0 | — | — | B4 | 79.0 | C2 | 3.0 | 4.2 | 8.1 |

### Comparative Example 1

### (Preparation of Elastic Layer-Forming Mixture)

24.9 parts by mass of polypropylene glycol (product name: PREMINOL S 4013F, commercially available from AGC Inc.), 24.0 parts by mass of polypropylene glycol (product name: UNIOL D-4000, commercially available from NOF Corporation), 3.1 parts by mass of xylylene diisocyanate (XDI) (commercially available from Tokyo Chemical Industry Co., Ltd.), and 500 ppm of 1,4-diazabicyclo[2.2.2]octane-2-methanol (product name: RZETA, commercially available from Tosoh Corporation) as a curing catalyst were put into a closed mixer, and the mixture was stirred for 4 hours in the closed mixer adjusted to 100° C. to synthesize a polyether having two isocyanate groups.

41.5 parts by mass of polycarbonate diol (product name: Duranol G3452, commercially available from Asahi Kasei Corporation) was mixed therewith. Then, the mixture was additionally stirred for 2 hours in a closed mixer adjusted to 100° C. to synthesize a urethane reactive emulsifier having two hydroxyl groups, and a dispersion in which droplets containing at least a part of the urethane reactive emulsifier were dispersed in the polycarbonate diol was obtained.

2.0 parts by mass of carbon black (product name: Denka Black powder, commercially available from Denka Co., Ltd.) was added to the dispersion, and the mixture was stirred using a rotation and revolution vacuum defoaming mixer for 3 minutes under conditions of a rotational speed of 800 rpm and a revolution speed of 1,600 rpm to obtain a dispersion in which carbon black was dispersed.

Next, 0.1 parts by mass of xylylene diisocyanate (XDI) (commercially available from Tokyo Chemical Industry Co., Ltd.) and 4.6 parts by mass of polyisocyanate (product name: Millionate MR-200, commercially available from Tosoh Corporation) were added to the dispersion in which carbon black was dispersed, and the mixture was stirred using a rotation and revolution vacuum defoaming mixer for 2 minutes under conditions of a rotational speed of 800 rpm and a revolution speed of 1,600 rpm to obtain an elastic layer-forming mixture.

An electrophotographic roller according to Comparative Example 1 was obtained in the same manner as in Example 1 except that the elastic layer-forming mixture obtained in this manner was used. The obtained electrophotographic roller was evaluated in the same manner as in Example 1.

Regarding the results of Evaluation 1, the matrix and the domain were clearly phase-separated. In addition, it was confirmed that the matrix had a structure corresponding to polypropylene glycol, and the domain had a structure corresponding to polycarbonate diol. That is, the relationship between the domain and the matrix was reversed from that of the urethane elastomer according to Example 1.

### Comparative Example 2

### (Preparation of Elastic Layer-Forming Mixture)

20.1 parts by mass of polypropylene glycol (product name: PREMINOL S 4013F, commercially available from AGC Inc.), 19.2 parts by mass of polypropylene glycol (product name: UNIOL D-4000, commercially available from NOF Corporation), and 500 ppm of 1,4-diazabicyclo[2.2.2]octane-2-methanol (product name: RZETA, commercially available from Tosoh Corporation) as a curing catalyst were put into a closed mixer, and the mixture was stirred for 2 hours in the closed mixer adjusted to 100° C.

50.4 parts by mass of polycarbonate diol (product name: Duranol G3452, commercially available from Asahi Kasei Corporation) was mixed therewith. Then, the mixture was additionally stirred for 2 hours in the closed mixer adjusted to 100° C.

2.0 parts by mass of carbon black (product name: Denka Black powder, commercially available from Denka Co., Ltd.) was additionally added thereto, and the mixture was stirred using a rotation and revolution vacuum defoaming mixer for 3 minutes under conditions of a rotational speed of 800 rpm and a revolution speed of 1,600 rpm.

3.5 parts by mass of xylylene diisocyanate (XDI) (commercially available from Tokyo Chemical Industry Co., Ltd.) and 5.0 parts by mass of polyisocyanate (product name: Millionate MR-200, commercially available from Tosoh Corporation) were added thereto. The obtained mixture was stirred using a rotation and revolution vacuum defoaming mixer for 2 minutes under conditions of a rotational speed of 800 rpm and a revolution speed of 1,600 rpm to obtain an elastic layer-forming mixture.

An elastic layer was formed in the same manner as in Example 1 except that this elastic layer-forming mixture was used, and thereby an electrophotographic roller according to Comparative Example 2 was prepared. The obtained electrophotographic roller was evaluated in the same manner as in Example 1. In this comparative example, the same raw materials as in Example 1 were used. However, no urethane reactive emulsifier was synthesized, and thus no dispersion in which droplets containing at least a part of the urethane reactive emulsifier were dispersed in polycarbonate diol was formed. Regarding the results of Evaluation 1 of the electrophotographic roller obtained in this comparative example, although the matrix and the domain were observed, the boundary between the matrix and the domain was very unclear. The reason for this was unclear, but the elastic layer according to this comparative example was produced without a step of forming a dispersion in which droplets containing at least a part of the urethane reactive emulsifier were dispersed in polycarbonate diol. Therefore, in the procedure of forming the elastic layer, although polycarbonate diol and polypropylene glycol were phase-separated due to the difference in compatibility between polypropylene glycol and polycarbonate diol, a region in which polycarbonate diol and polypropylene glycol were mixed was formed around the droplets containing polycarbonate diol, which was thought to make the boundary between the matrix and the domain unclear. In addition, it was thought that, in the elastic layer according to this comparative example, almost no urethane bonds were formed at the interface between the domain and the matrix, which was probably why the result of Evaluation 4 was as large as 3.00 μm as a result.

### Comparative Example 3

(Preparation of Elastic Layer-Forming Mixture) 46.6 parts by mass of polycarbonate diol (product name: Kuraray Polyol C-2090, commercially available from Kuraray Co., Ltd.), 44.8 parts by mass of silicone particles (product name: KMP-598, commercially available from Shin-Etsu Chemical Co., Ltd.) as soft resin particles and 500 ppm of 1,4-diazabicyclo[2.2.2]octane-2-methanol (product name: RZETA, commercially available from Tosoh Corporation) as a curing catalyst were put into a closed mixer, and the mixture was stirred for 4 hours in the closed vacuum mixer adjusted to 100° C.

In addition, 2.0 parts by mass of carbon black (product name: Denka Black, commercially available from Denka Co., Ltd.) was added, and the mixture was stirred using a rotation and revolution vacuum defoaming mixer for 3 minutes under conditions of a rotational speed of 800 rpm and a revolution speed of 1,600 rpm.

2.6 parts by mass of xylylene diisocyanate (XDI) (commercially available from Tokyo Chemical Industry Co., Ltd.) and 4.2 parts by mass of polyisocyanate (product name: Millionate MR-200, commercially available from Tosoh Corporation) were added thereto. The obtained mixture was stirred using a rotation and revolution vacuum defoaming mixer for 2 minutes under conditions of a rotational speed of 800 rpm and a revolution speed of 1,600 rpm to obtain an elastic layer-forming mixture.

An elastic layer was formed in the same manner as in Example 1 except that this elastic layer-forming mixture was used, and thereby an electrophotographic roller according to Comparative Example 3 was prepared. The obtained electrophotographic roller was evaluated in the same manner as in Example 1. Here, in the evaluation of the electrophotographic roller according to this comparative example, silicone particles were regarded as domains for evaluation.

### Comparative Example 4

### (Preparation of Elastic Layer-Forming Mixture)

100.0 parts by mass of NBR (product name: N230SV, commercially available from JSR Corporation), 50.0 parts by mass of carbon black (product name: Toka Black #7360, commercially available from Tokai Carbon Co., Ltd.), 70.0 parts by mass of calcium carbonate (product name: NANOX #30, commercially available from Maruo Calcium Co., Ltd.), 7.0 parts by mass of zinc oxide (product name: zinc oxide, commercially available from Sakai Chemical Industry Co., Ltd.), and 2.8 parts by mass of zinc stearate (product name: SZ-2000, commercially available from Sakai Chemical Industry Co., Ltd.) were mixed in a pressure type kneader for 16 minutes under conditions of a filling rate of 70 vol % and a blade rotation speed of 30 rpm to obtain a matrix-forming unvulcanized rubber.

Next, 100.0 parts by mass of SBR (product name: TUFDENE 2003, commercially available from Asahi Kasei Corporation), 5.0 parts by mass of zinc oxide (product name: zinc oxide, commercially available from Sakai Chemical Industry Co., Ltd.), and 2.0 parts by mass of zinc stearate (product name: SZ-2000, commercially available from Sakai Chemical Industry Co., Ltd.) were mixed in a pressure type kneader for 16 minutes under conditions of a filling rate of 70 vol % and a blade rotation speed of 30 rpm to obtain a domain-forming unvulcanized rubber.

In addition, 65.0 parts by mass of the matrix-forming unvulcanized rubber and 35.0 parts by mass of the domain-forming unvulcanized rubber were mixed in a pressure type kneader for 16 minutes under conditions of a filling rate of 70 vol % and a blade rotation speed of 30 rpm to obtain an unvulcanized rubber mixture.

100.0 parts by mass of the obtained unvulcanized rubber mixture, 3.0 parts by mass of sulfur (product name: SULFAX PMC, commercially available from Tsurumi Chemical Industry Co., Ltd.), and 2.0 parts by mass of tetrabenzyl thiuram disulfide (product name: TBZTD, commercially available from Sanshin Chemical Industry Co., Ltd.) were turned left and right a total of 20 times using an open roll at a front roll rotation speed of 10 rpm, a rear roll rotation speed of 8 rpm, and a roll gap of 2 mm, and then tightly passed 10 times at a roll gap of 0.5 mm to obtain an elastic layer-forming mixture.

### (Preparation of Electrophotographic Roller)

A primer (product name: Metaloc N-33, commercially available from Toyokagaku Kenkyusho Co., Ltd.) was applied to a SUS304 shaft core with a diameter of 6 mm and a length of 250 mm and baked at 130° C. for 30 minutes.

Next, a die with an inner diameter of 14.0 mm was attached to a tip of a crosshead extruder having a shaft core supply mechanism and an unvulcanized rubber roller discharge mechanism and the crosshead extruder was preheated to 80° C. The transport speed of the shaft core was adjusted to 60 mm/sec, the elastic layer-forming mixture was supplied from the extruder, and the outer circumferential part of the shaft core was covered with the elastic layer-forming mixture in the crosshead to obtain an unvulcanized rubber roller.

The obtained unvulcanized rubber roller was heated in a hot air vulcanizing furnace at 170° C. for 60 minutes to obtain a roller in which the elastic layer was formed on the outer circumferential part of the shaft core. Then, the ends of the elastic layer were removed, and the surface of the elastic layer was polished with a rotary grindstone to obtain an electrophotographic roller with a length of 225 mm and an elastic layer thickness of 2.0 mm.

The obtained electrophotographic roller was evaluated in the same manner as in Example 1.

The evaluation results of Examples 1 to 18 and Comparative Examples 1 to 3 are shown in Table 5-1 to Table 5-4 and Table 6.

TABLE 5-1

| | | | | | | | Eval- | Evaluation 7 | | | | |
|---|---|---|---|---|---|---|---|---|---|---|---|---|
| | | | | | | Eval- | uation | | | Proportion of | Evaluation 8 | |
| | | | | | | uation | 6 | | | number of | | Proportion of |
| | | Eval- | | | | 5 | Proportion | Total | Average | domains | Aver- | number of |
| | Evaluation | uation | Eval- | Eval- | Eval- | Elastic | of area of | cross- | cross- | having a | age | domains |
| | 1 | 2 | uation | uation | uation | modulus | conductive | sectional | sectional | cross-sectional | cir- | having a |
| | Confirmation | Micro | 3 | 3 | 4 | of | filler | area of | area of | area | cularity | circularity |
| | and analysis | rubber | A | B | Strain | matrix | present | domains | domains | of 0.1 to 13.0 | of | of 0.60 |
| | of matrix and domain | hardness | (mV) | (mV) | (μm) | (MPa) | (%) | (area %) | (area %) | area % (%) | domains | to 0.95 (%) |
| Example | Clear phase separation | 22 | 60 | 150 | 1.00 | 2 | 96 | 45 | 13.0 | 70 | 0.95 | 90 |
| 1 | between M and D | | | | | | | | | | | |
| | M: Structure derived from | 22 | 60 | 150 | 1.00 | 2 | 97 | 45 | 13.0 | 70 | 0.95 | 90 |
| | polycarbonate urethane | | | | | | | | | | | |
| | D: Structure derived from | 22 | 60 | 150 | 1.00 | 2 | 97 | 45 | 13.0 | 70 | 0.95 | 90 |
| | PPG | | | | | | | | | | | |
| Example | Same as above | 38 | 100 | 250 | 0.30 | 8 | 97 | 15 | 0.1 | 70 | 0.95 | 90 |
| 2 | | 38 | 100 | 250 | 0.30 | 8 | 95 | 15 | 0.1 | 70 | 0.95 | 90 |
| | | 38 | 100 | 250 | 0.30 | 8 | 97 | 15 | 0.1 | 70 | 0.95 | 90 |
| Example | Same as above | 35 | 100 | 250 | 0.40 | 8 | 96 | 45 | 0.1 | 70 | 0.95 | 90 |
| 3 | | 35 | 100 | 250 | 0.40 | 8 | 96 | 45 | 0.1 | 70 | 0.95 | 90 |
| | | 35 | 100 | 250 | 0.40 | 8 | 95 | 45 | 0.1 | 70 | 0.95 | 90 |
| Example | Same as above | 30 | 80 | 210 | 0.50 | 5 | 97 | 29 | 6.5 | 90 | 0.95 | 90 |
| 4 | | 30 | 80 | 210 | 0.50 | 5 | 98 | 30 | 6.6 | 90 | 0.95 | 90 |
| | | 30 | 80 | 210 | 0.50 | 5 | 97 | 30 | 6.6 | 90 | 0.95 | 90 |
| Example | Clear phase separation | 30 | 85 | 210 | 0.50 | 5 | 96 | 30 | 6.0 | 90 | 0.95 | 90 |
| 5 | between M and D | | | | | | | | | | | |
| | M: Structure derived from | 30 | 85 | 210 | 0.50 | 5 | 97 | 30 | 6.0 | 90 | 0.95 | 90 |
| | polycarbonate urethane | | | | | | | | | | | |
| | D: Structure derived from | 30 | 85 | 210 | 0.50 | 5 | 97 | 31 | 6.1 | 90 | 0.94 | 90 |
| | tetrahydrofuran-neopentyl | | | | | | | | | | | |
| | glycol copolymer | | | | | | | | | | | |
| Example | Clear phase separation | 25 | 60 | 210 | 0.60 | 5 | 98 | 45 | 13.0 | 70 | 0.95 | 90 |
| 6 | between M and D | | | | | | | | | | | |
| | M: Structure derived from | 25 | 60 | 210 | 0.60 | 5 | 96 | 45 | 13.0 | 70 | 0.95 | 90 |
| | polycarbonate urethane | | | | | | | | | | | |
| | D: Structure derived from | 25 | 60 | 210 | 0.60 | 5 | 98 | 45 | 13.0 | 70 | 0.95 | 90 |
| | PPG | | | | | | | | | | | |

TABLE 5-2

| | | | | | | | Eval- | | | | | |
|---|---|---|---|---|---|---|---|---|---|---|---|---|
| | | | | | | | uation | Evaluation 7 | | | | |
| | | | | | | | 6 | | | Proportion | | |
| | | | | | | | Pro- | | | of number | Evaluation 8 | |
| | | | | | | Eval- | portion | | | of domains | | Proportion |
| | | Eval- | | | | uation | of area | | | having a | | of |
| | | uation | | | | 5 | of | Total | Average | cross- | Aver | number of |
| | Evaluation | 2 | Eval- | Eval- | Eval- | Elastic | con- | cross- | cross- | sectional | age | domains |
| | 1 | Micro | uation | uation | uation | modulus | ductive | sectional | sectional | area | cir- | having a |
| | Confirmation and | rubber | 3 | 3 | 4 | of | filler | area of | area of | of 0.1 to | cularity | circularity |
| | analysis of matrix | hard- | A | B | Strain | matrix | present | domains | domains | 13.0 area | of | of 0.60 to |
| | and domain | ness | (mV) | (mV) | (μm) | (MPa) | (%) | (area %) | (area %) | % (%) | domains | 0.95 (%) |
| Example | Clear phase separation | 35 | 100 | 210 | 0.40 | 5 | 96 | 15 | 0.1 | 70 | 0.95 | 90 |
| 7 | between M and D | | | | | | | | | | | |
| | M: Structure derived from | 35 | 100 | 210 | 0.40 | 5 | 98 | 15 | 0.1 | 70 | 0.95 | 90 |
| | polycarbonate urethane | | | | | | | | | | | |
| | D: Structure | 35 | 100 | 210 | 0.40 | 5 | 95 | 15 | 0.1 | 70 | 0.95 | 90 |
| | derived from PPG | | | | | | | | | | | |
| Example | Same as above | 30 | 80 | 210 | 0.50 | 5 | 95 | 30 | 6.6 | 90 | 0.60 | 70 |
| 8 | | 30 | 80 | 210 | 0.70 | 5 | 95 | 30 | 6.6 | 90 | 0.60 | 70 |
| | | 30 | 80 | 210 | 0.50 | 5 | 96 | 31 | 6.7 | 90 | 0.61 | 71 |
| Example | Clear phase separation | 21 | 80 | 130 | 1.00 | 1 | 95 | 29 | 6.5 | 90 | 0.95 | 90 |
| 9 | between M and D | | | | | | | | | | | |
| | M: Structure derived from | 21 | 80 | 130 | 1.00 | 1 | 96 | 30 | 6.6 | 90 | 0.95 | 90 |
| | polyester urethane | | | | | | | | | | | |
| | D: Structure derived | 21 | 80 | 130 | 1.00 | 1 | 96 | 30 | 6.6 | 90 | 0.95 | 90 |
| | from PPG | | | | | | | | | | | |
| Example | Clear phase separation | 21 | 85 | 130 | 1.00 | 1 | 96 | 30 | 6.6 | 90 | 0.95 | 90 |
| 10 | between M and D | | | | | | | | | | | |
| | M: Structure derived from | 21 | 85 | 130 | 1.00 | 1 | 96 | 30 | 6.6 | 90 | 0.95 | 90 |
| | polycarbonate urethane | | | | | | | | | | | |
| | D: Structure derived from | 21 | 85 | 130 | 1.00 | 1 | 96 | 30 | 6.6 | 90 | 0.95 | 90 |
| | polytetramethylene glycol | | | | | | | | | | | |
| Example | Clear phase separation | 39 | 80 | 280 | 0.30 | 10 | 96 | 30 | 6.6 | 90 | 0.95 | 90 |
| 11 | between M and D | | | | | | | | | | | |
| | M: Structure derived from | 39 | 80 | 280 | 0.30 | 10 | 97 | 30 | 6.6 | 90 | 0.95 | 90 |
| | polycarbonate urethane | | | | | | | | | | | |
| | D: Structure derived | 39 | 80 | 280 | 0.30 | 10 | 97 | 29 | 6.6 | 90 | 0.95 | 90 |
| | from PPG | | | | | | | | | | | |
| Example | Same as above | 21 | 40 | 210 | 0.70 | 5 | 96 | 50 | 15.0 | 60 | 0.95 | 90 |
| 12 | | 21 | 40 | 210 | 0.70 | 5 | 95 | 51 | 15.1 | 59 | 0.95 | 90 |
| | | 21 | 40 | 210 | 0.70 | 5 | 97 | 50 | 15.0 | 60 | 0.95 | 90 |

TABLE 5-3

| | | | | | | | | | | | Evaluation 8 | |
|---|---|---|---|---|---|---|---|---|---|---|---|---|
| | | | | | | | | Evaluation 7 | | | | Proportion |
| | | | | | | | Eval- | | | Proportion | | of |
| | | | | | | Eval- | uation | | | of number | | number |
| | | Eval- | | | | uation | 6 | | | of domains | | of |
| | | uation | | | | 5 | Proportion | Total | Average | having a | | domains |
| | Evaluation | 2 | Eval- | Eval- | Eval- | Elastic | of area of | cross- | cross- | cross- | Average | having a |
| | 1 | Micro | uation | uation | uation | modulus | conductive | sectional | sectional | sectional | cir- | circularity |
| | Confirmation and | rubber | 3 | 3 | 4 | of | filler | area of | area of | area of 0.1 | cularity | of 0.60 |
| | analysis of matrix | hard- | A | B | Strain | matrix | present | domains | domains | to 13.0 | of | to 0.95 |
| | and domain | ness | (mV | (mV) | (μm) | (MPa) | (%) | (area %) | (area %) | area % (%) | domains | (%) |
| Example | Clear phase separation | 30 | 80 | 210 | 0.70 | 5 | 95 | 30 | 6.6 | 90 | 0.50 | 60 |
| 13 | between M and D | | | | | | | | | | | |
| | M: Structure derived from | 30 | 80 | 210 | 0.50 | 5 | 93 | 30 | 6.6 | 90 | 0.50 | 60 |
| | polycarbonate urethane | | | | | | | | | | | |
| | D: Structure derived | 30 | 80 | 210 | 0.50 | 5 | 92 | 30 | 6.6 | 90 | 0.50 | 60 |
| | from PPG | | | | | | | | | | | |
| Example | Clear phase separation | 20 | 40 | 130 | 1.00 | 1 | 93 | 49 | 14.9 | 61 | 0.95 | 90 |
| 14 | between M and D | | | | | | | | | | | |
| | M: Structure derived from | 20 | 40 | 130 | 1.00 | 1 | 94 | 50 | 15.0 | 60 | 0.95 | 90 |
| | polyester urethane | | | | | | | | | | | |
| | D: Structure derived | 20 | 40 | 130 | 1.00 | 1 | 92 | 50 | 15.0 | 60 | 0.95 | 90 |
| | from PPG | | | | | | | | | | | |
| Example | Clear phase separation | 40 | 140 | 280 | 0.10 | 10 | 92 | 9 | 0.04 | 60 | 0.95 | 90 |
| 15 | between M and D | | | | | | | | | | | |
| | M: Structure derived from | 40 | 140 | 280 | 0.10 | 10 | 92 | 10 | 0.05 | 60 | 0.95 | 90 |
| | polycarbonate urethane | | | | | | | | | | | |
| | D: Structure derived | 40 | 140 | 280 | 0.10 | 10 | 94 | 10 | 0.05 | 60 | 0.95 | 90 |
| | from PPG | | | | | | | | | | | |
| Example | Clear phase separation | 20 | 40 | 130 | 1.00 | 1 | 94 | 50 | 15.0 | 60 | 0.50 | 60 |
| 16 | between M and D | | | | | | | | | | | |
| | M: Structure derived from | 20 | 40 | 130 | 1.00 | 1 | 92 | 50 | 15.0 | 60 | 0.50 | 60 |
| | polyester urethane | | | | | | | | | | | |
| | D: Structure derived | 20 | 40 | 130 | 1.00 | 1 | 93 | 50 | 15.0 | 60 | 0.50 | 60 |
| | from PPG | | | | | | | | | | | |
| Example | Clear phase separation | 40 | 140 | 280 | 0.50 | 10 | 92 | 10 | 0.05 | 60 | 0.50 | 60 |
| 17 | between M and D | | | | | | | | | | | |
| | M: Structure derived from | 40 | 140 | 280 | 0.10 | 10 | 93 | 10 | 0.05 | 60 | 0.50 | 60 |
| | polycarbonate urethane | | | | | | | | | | | |
| | D: Structure derived | 40 | 140 | 280 | 0.10 | 10 | 93 | 11 | 0.06 | 60 | 0.50 | 60 |
| | from PPG | | | | | | | | | | | |
| Example | Same as above | 50 | 140 | 310 | 0.05 | 13 | 93 | 10 | 0.05 | 60 | 0.95 | 90 |
| 18 | | 50 | 140 | 310 | 0.05 | 13 | 95 | 10 | 0.05 | 60 | 0.95 | 90 |
| | | 50 | 140 | 310 | 0.05 | 13 | 93 | 10 | 0.05 | 60 | 0.95 | 90 |

TABLE 5-4

| | | | | | | | | Evaluation 7 | | | | |
|---|---|---|---|---|---|---|---|---|---|---|---|---|
| | | | | | | | | | | Proportion | | |
| | | | | | | | | | | of | | |
| | | | | | | | Eval- | | | number of | Evaluation 8 | |
| | | | | | | Eval- | uation | | | domains | | Proportion |
| | | Eval- | | | | uation | 6 | | | having | | of |
| | | uation | | | | 5 | Proportion | Total | Average | a cross- | Aver- | number of |
| | Evaluation | 2 | Eval- | Eval- | Eval- | Elastic | of area of | cross- | cross- | sectional | age | domains |
| | 1 | Micro | uation | uation | uation | modulus | conductive | sectional | sectional | area of | cir- | having a |
| | Confirmation | rubber | 3 | 3 | 4 | of | filler | area of | area of | 0.1 to 13.0 | cularity | circularity |
| | and analysis | hard- | A | B | Strain | matrix | present | domains | domains | area % | of | of 0.60 to |
| | of matrix and domain | ness | (mV) | (mV) | (μm) | (MPa) | (%) | (area %) | (area %) | (%) | domains | 0.95 (%) |
| Com- | Clear phase separation | 16 | 150 | 60 | 5.00 | 0.6 | 97 | 45 | 0.05 | 60 | 0.95 | 90 |
| parative | between M and D | | | | | | | | | | | |
| Example 1 | M: Structure derived from | 16 | 150 | 60 | 5.00 | 0.6 | 96 | 45 | 0.05 | 60 | 0.95 | 90 |
| | PPG | | | | | | | | | | | |
| | D: Structure derived from | 16 | 150 | 60 | 5.00 | 0.6 | 96 | 45 | 0.05 | 60 | 0.95 | 90 |
| | polycarbonate urethane | | | | | | | | | | | |
| Com- | Unclear phase separation | 18 | 80 | 120 | 3.00 | 0.8 | 80 | 45 | 13.0 | 70 | 0.50 | 60 |
| parative | between M and D | | | | | | | | | | | |
| Example 2 | M: Structure derived from | 18 | 80 | 120 | 4.00 | 0.8 | 81 | 45 | 13.0 | 70 | 0.50 | 60 |
| | polycarbonate urethane | | | | | | | | | | | |
| | D: Structure derived from | 18 | 80 | 120 | 3.00 | 0.8 | 79 | 45 | 13.0 | 70 | 0.50 | 60 |
| | PPG | | | | | | | | | | | |
| Com- | Clear phase separation | 60 | 220 | 310 | 0.10 | 13 | 100 | 50 | 5.3 | 90 | 0.95 | 90 |
| parative | between M and D | | | | | | | | | | | |
| Example 3 | M: Structure derived from | 60 | 220 | 310 | 0.10 | 13 | 100 | 50 | 5.3 | 90 | 0.95 | 90 |
| | polycarbonate urethane | | | | | | | | | | | |
| | D: Silicone | 60 | 220 | 310 | 0.10 | 13 | 100 | 51 | 5.4 | 90 | 0.95 | 90 |
| Com- | Clear phase separation | 50 | 300 | 350 | 2.50 | 0.9 | 85 | 35 | 0.1 | 70 | 0.50 | 60 |
| parative | between M and D | | | | | | | | | | | |
| Example 4 | M: Structure derived from | 50 | 300 | 350 | 1.50 | 0.9 | 86 | 34 | 0.1 | 70 | 0.50 | 60 |
| | NBR | | | | | | | | | | | |
| | D: Structure derived from | 50 | 300 | 350 | 1.50 | 0.9 | 85 | 35 | 0.1 | 70 | 0.50 | 60 |
| | SBR | | | | | | | | | | | |

In Tables 5-1 to 5-4, M represents a matrix, D represents a domain, A and B represent parameters A and B indicating the viscoelasticity term, and PPG represents polypropylene glycol.

TABLE 6

| | | Evaluation | | | | | |
|---|---|---|---|---|---|---|---|
| | | 9 | | | | Evaluation | |
| | | Streak | | Evaluation | Evaluation | 10-3 | Evaluation |
| | | (number | Streak | 10-1 | 10-2 | Image defects | 11 |
| | | of | (longi tudinal | Scraping of | Toner melt | due to toner | Solid |
| | | sheets) | direction) | ends | adhesion | melt adhesion | density |
| Example | 1 | A | A | Not occurred | Not occurred | Not occurred | OK |
| | 2 | A | A | Not occurred | Not occurred | Not occurred | OK |
| | 3 | A | A | Not occurred | Not occurred | Not occurred | OK |
| | 4 | A | A | Not occurred | Not occurred | Not occurred | OK |
| | 5 | A | A | Not occurred | Not occurred | Not occurred | OK |
| | 6 | A | A | Not occurred | Not occurred | Not occurred | OK |
| | 7 | A | A | Not occurred | Not occurred | Not occurred | OK |
| | 8 | A | B | Not occurred | Not occurred | Not occurred | OK |
| | 9 | B | B | Occurred on | Not occurred | Not occurred | OK |
| | | | | 9,000^{th} sheet | | | |
| | 10 | B | B | Occurred on | Not occurred | Not occurred | OK |
| | | | | 9,000^{th} sheet | | | |
| | 11 | A | A | Not occurred | Occurred on | Not occurred | OK |
| | | | | | 9,000^{th} sheet | | |
| | 12 | B | B | Occurred on | Not occurred | Not occurred | OK |
| | | | | 9,000^{th} sheet | | | |
| | 13 | B | B | Not occurred | Not occurred | Not occurred | OK |
| | 14 | B | B | Occurred on | Not occurred | Not occurred | OK |
| | | | | 8,000^{th} sheet | | | |
| | 15 | A | A | Not occurred | Occurred on | Not occurred | OK |
| | | | | | 8,000^{th} sheet | | |
| | 16 | B | B | Occurred on | Not occurred | Not occurred | OK |
| | | | | 8,000^{th} sheet | | | |
| | 17 | B | B | Not occurred | Occurred on | Not occurred | OK |
| | | | | | 8,000^{th} sheet | | |
| | 18 | A | A | Not occurred | Occurred on | Not occurred | OK |
| | | | | | 8,000^{th} sheet | | |
| Comparative | 1 | C | B | Occurred on | Not occurred | Not occurred | OK |
| Example | | | | 5,000^{th} sheet | | | |
| | 2 | C | C | Occurred on | Not occurred | Not occurred | OK |
| | | | | 5,000^{th} sheet | | | |
| | 3 | A | A | Not occurred | Occurred on | Occurred on | OK |
| | | | | | 5,000^{th} sheet | 5,000^{th} sheet | |
| | 4 | B | C | Occurred on | Occurred on | Not occurred | OK |
| | | | | 5,000^{th} sheet | 8,000^{th} sheet | | |

In the electrophotographic rollers according to Examples 1 to 18, the micro rubber hardness of the elastic layer was low, and a plurality of domains were dispersed in the matrix containing a urethane elastomer. In addition, the parameter B indicating the viscoelasticity term of the matrix was larger than the parameter A indicating the viscoelasticity term of the domain, the circularity of the domain was high, the elastic modulus of the matrix was also high, and thus good results were obtained in the evaluation of streaky image defects. In addition, although toner melt adhesion was observed in some electrophotographic rollers, no image defects due to toner melt adhesion occurred.

On the other hand, in the electrophotographic roller according to Comparative Example 1, the parameter A indicating the viscoelasticity term of the domain was larger than the parameter B indicating the viscoelasticity term of the matrix. As a result, since A>B was not satisfied, an excess decrease in the micro rubber hardness occurred and the ends were scraped off.

In the electrophotographic roller according to Comparative Example 2, a polyether was synthesized and mechanically phase-separated to form a matrix-domain structure without a step of synthesizing a urethane reactive emulsifier. Therefore, the phase separation was unclear, and the circularity of the domain also decreased. As a result, the micro rubber hardness was less than 20 degrees, the strain was 3 μm, the ends were scraped off and streaky images occurred.

In the electrophotographic roller according to Comparative Example 3, although flexible particles were used as the domains, in order to maintain the shapes of the particles, the parameter A indicating the viscoelasticity term was much larger than that of the domain according to the present disclosure, the parameter B indicating the viscoelasticity term of the matrix should also be made larger, and as a result, the micro rubber hardness was 60. Thus, toner melt adhesion occurred. In addition, in image evaluation, image defects due to toner melt adhesion occurred on the 8,410th sheet.

In the electrophotographic roller according to Comparative Example 4, since the elastic layer was made of vulcanized rubber, the wear resistance was low, and the ends were scraped off.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electrophotographic member comprising a conductive elastic layer, wherein
the elastic layer comprises a urethane elastomer and a conductive filler,
the urethane elastomer comprises a matrix and a plurality of domains dispersed in the matrix,
a relationship between a parameter A indicating a viscoelasticity term of the domain and a parameter B indicating a viscoelasticity term of the matrix, which are measured in a viscoelasticity image of a cross section of the elastic layer in which the domain and the matrix are exposed under a scanning probe microscope, satisfies A<B,
micro rubber hardness of the elastic layer at a temperature of 23° C. is 20 to 50 degrees, and
when a Vickers indenter is brought into contact with the matrix on an outer surface of the elastic layer at a temperature of 23° C., the Vickers indenter is pressed into the elastic layer at a load rate of 10 mN/30 seconds, a load of 10 mN is maintained for 60 seconds, and the load is then removed, a strain 5 seconds after unloading is not more than 1.00 μm.

2. The electrophotographic member according to claim 1,
wherein the conductive filler is conductive carbon black.

3. The electrophotographic member according to claim 1,
wherein, when a length of the elastic layer in a longitudinal direction is L, at a total of three locations including a center of the elastic layer in the longitudinal direction and two locations of L/4 from both ends of the elastic layer toward the center, for each cross section of the elastic layer in a thickness direction in which the domain and the matrix are exposed, in case where a square observation region having a side of 50 μm is a thickness region from the outer surface of the elastic layer to a position of a depth of 100 μm, each observation region satisfies requirement (1) and requirement (2).
Requirement (1): The proportion of the total cross-sectional area of the domains present in the observation region is 15 to 45 area % of the area of the observation region.
Requirement (2): Among the domains present in the observation region, the proportion of the number of domains having a cross-sectional area of 0.1 to 13.0 area % relative to the area of the observation region is at least 70%.

4. The electrophotographic member according to claim 3,
wherein the proportion of the number of domains having a circularity of 0.60 to 0.95 in the observation region is at least 70%.

5. The electrophotographic member according to claim 1
wherein the matrix comprises a polycarbonate structure represented by Formula (1), and
the domain has a polyether structure represented by Formula (2): 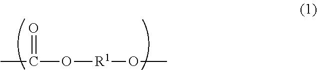
(in Formula (1), R¹ is an alkylene group having 3 to 9 carbon atoms) 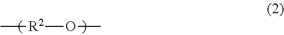
(in Formula (2), R² is an alkylene group having 3 to 5 carbon atoms).

6. The electrophotographic member according to claim 5,
wherein R¹ is an alkylene group having a branched structure and 3 to 9 carbon atoms.

7. The electrophotographic member according to claim 5,
wherein R² is an alkylene group having a branched structure and 3 to 5 carbon atoms.

8. The electrophotographic member according to claim 1,
wherein, when the length of the elastic layer in a longitudinal direction is L, at a total of three locations including the center of the elastic layer in the longitudinal direction and two locations of L/4 from both ends of the elastic layer toward the center, for each cross section of the elastic layer in a thickness direction in which the domain and the matrix are exposed, in a case where a square observation region with a side of 50 μm is a thickness region from the outer surface of the elastic layer to a position of a depth of 100 μm, each observation region satisfies requirement (3).
Requirement (3): The proportion of the area of the conductive filler contained in the matrix present in the observation region relative to the total area of the conductive filler present in the observation region is at least 95%.

9. The electrophotographic member according to claim 1
wherein a value ratio (A/B) of the parameter A to the parameter B is not more than 0.65.

10. A process cartridge that is detachable from a main body of an electrophotographic image forming apparatus, comprising the electrophotographic member according to claim 1

11. An electrophotographic image forming apparatus comprising the electrophotographic member according to claim 1.
